(19) United States
(12) Patent Application Publication
(10) Pub. No.: US 2009/0188148 A1
(43) Pub. Date: Jul. 30, 2009

(54) Autonomous Decoy Device and Methods of Use

(76) Inventors: Justin Orris, Lone Tree, CO (US); Benjamen Butcher, Denver, CO (US); Fred A. Marconi, JR., Erieville, NY (US)

Correspondence Address: Leyendecker & Lemire, LLC, C/O PORTFOLIO IP, P.O. BOX 52050, MINNEAPOLIS, MN, 55402, US

(21) Appl. No.: 12/363,566

(22) Filed: Jan. 30, 2009

Related U.S. Application Data
(60) Provisional application No. 61/024,884, filed on Jan. 30, 2008.

(51) Int. Cl. A01M 31/06

(52) U.S. Cl. 43/3; 43/2

(57) ABSTRACT

An autonomous decoy device is disclosed. The autonomous decoy comprises a decoy shell, a propulsion system, the propulsion system, a steering apparatus, a receiver, a memory, and a microcontroller. The decoy shell has a form resembling an animal in life size or near life size proportions. The propulsion system is adapted to move the decoy device in or on a desired medium and the steering apparatus is adapted to control the direction of movement of the decoy device. The receiver is adapted to receive an electromagnetic signal and determine a relative strength of the signal. The memory is adapted to store at least one instruction set. The microcontroller is adapted to control the propulsion system and the steering apparatus based on the at least one instruction set and the relative strength of the signal. Various autonomous routines and methods of use are further described herein.

### CROSS REFERENCE TO RELATED APPLICATIONS

The present invention is a Non Provisional Application of Provisional Application No. 61024884 filed on Jan. 30, 2008 having two of the three same inventors. The parent application is incorporated herein by reference.

### FIELD OF THE INVENTION

The present invention relates generally to devices and methods for hunting. More particularly, but not by way of limitation, the present invention relates to devices and methods for hunting waterfowl near a body of water.

### BACKGROUND

Hunting waterfowl with the aide of decoys has been practiced for many years. A hunter attempts to attract game by creating and maintaining a natural and inviting habitat. Decoys are spread on a body of water to induce waterfowl game to land and join the decoys that are already in the water. However, a body of water with decoys floating aimlessly or deathly still quickly loses the appearance of a natural and inviting habitat for game to join.

More effective landing zones for waterfowl game can be achieved by a lifelike spread and movement of decoys. Different sized landing zones created by the spread of decoys are desirable depending on the type and quantity of waterfowl being hunted. For example, a smaller landing zone created by duck decoys positioned relatively close to each other may be more inviting to single, pairs, or a small group of ducks. However, a larger landing zone created by a plurality of relatively far dispersed goose decoys will likely be more inviting a large flock of geese.

A large number of decoys are typically used during a hunt. Utilizing anywhere from one dozen to ten dozen decoys is not uncommon when duck hunting. The number of decoys utilized is typically even greater, sometimes over twenty dozen, when hunting for geese. Retrieving the decoys can be very time consuming and deter from the enjoyment of hunting. Second, many prior art decoys can drift to deeper parts of the body water. A hunter wearing waders or otherwise can find himself or herself in a perilous situation attempting to retrieve a decoy for deep water.

Furthermore, decoys can often get stuck in the natural environment of a body of water, such as a willow bed, pond scum, and fallen tree limbs. Decoys are likely to become stuck when decoys are left to float on a body of water without restraint. If multiple decoys are tethered the chance of the decoy getting stuck in the natural environment of a body of water is reduced, but the lack of the decoy's movement makes the decoy look unnatural.

Remote control decoys have been contemplated, but lack effectiveness in that they require a hunter's attention and the use of his hands to maneuver. The deficiency in such an application is evident from the fact that if a hunter must regularly handle a remote control to maneuver a decoy, the hunter will not have his or her gun in hand and ready to fire or be able will be not be able to use one of the plurality of items that he or she must have readily available such as a duck call or dog whistle while awaiting game in a hunting blind.

Nevertheless, as many hunters will attest, movement of a decoy or plurality of decoys on the water surface is desirable because it attracts approaching game to a seemingly natural and safe habitat. However, known art fails to provide an easily deployable and retrievable method of attracting game with one or more decoys that makes the body of water used for hunting waterfowl appear natural and safe to approaching game.

### SUMMARY OF THE DRAWINGS

FIG. 1 is an perspective view and component breakout of an autonomous decoy according to an embodiment of the present invention.

FIG. 2 is a schematic diagram of the autonomous decoy and a beacon according to an embodiment of the present invention.

FIG. 3 is an overhead view showing a first autonomous free swim routine of the autonomous decoy according to an embodiment of the present invention

FIG. 4 is an overhead view showing a second autonomous free swim routine of the autonomous decoy according to an embodiment of the present invention.

FIG. 5 is an overhead view showing an autonomous unstuck routine of the autonomous decoy according to an embodiment of the present invention.

FIG. 6 is an overhead view showing autonomous converge routines of the autonomous decoy according to an embodiment of the present invention.

FIG. 7 is a flow chart illustrating the operation and algorithm used for the first autonomous free swim routine of the autonomous decoy according to an embodiment of the present invention.

FIG. 8 is a flow chart illustrating the operation and algorithm used for the second autonomous free swim routine of the autonomous decoy according to an embodiment of the present invention.

FIG. 9 is a flow chart illustrating the operation and algorithm used for the autonomous unstuck routine of the autonomous decoy according to an embodiment of the present invention.

FIG. 10 is a flow chart illustrating the operation and algorithm used for the autonomous converge routines of the autonomous decoy according to an embodiment of the present invention.

FIG. 11 is a flow chart describing an exemplary method of using an embodiment of the present invention for hunting.

### DETAILED DESCRIPTION

The present invention in its broadest form comprises one or more autonomous decoy devices such as, but not limited to, autonomous waterfowl decoys, that are adapted to swim in a body of water or to walk on land wherein all the decoys remain substantially within a predetermined area relative to each other autonomously without the requirement of regular user control. The autonomy of the autonomous decoy device allows the user's hands to remain free to hold and aim a gun in a position.

Embodiments of an autonomous decoy device comprise a decoy body, a microcontroller, a wireless transceiver, and a propulsion system. One or more autonomous decoys operate in conjunction with a beacon or a master decoy. The beacon or master decoy transmits a wireless reference signal that is received by one or more autonomous decoy devices. It is to be appreciated that the wireless reference signal as described comprises an RF signal although any suitable electromagnetic frequency may be utilized. For instance, variations are contemplated that use infrared signals as are embodiments that utilize microwave signals. Other embodiments may utilize visible light or sound as a reference signal. Yet other variations may rely on GPS signals to monitor the location of one or more autonomous decoy devices in the flock and rely on RF primarily for communicating instructional signals thereto.

The autonomous decoy device will make various autonomous movement decisions based on both the strength or power lever of the signal received from the beacon and the information encoded in the wireless reference signal in conjunction with the associated logic in its microcontroller.

The autonomous decoy device may consist of a variety of decoy bodies such as, but not limited to, ducks, geese, blue herons, cranes, swans, crows, turkeys, doves, deer, antelope, and elk. Furthermore, variations in the decoy body of a given bird or mammal may exist including a male and female version. For instance, there are over fifty different species of ducks and decoy variations thereof are very relevant to the particular hunting situation. A microcontroller provides the logic and autonomous routines for which the autonomous decoy device operates. A propulsion system provides the autonomous movement for the autonomous decoy device. In some embodiments, the propulsion system is a pump adapted to force water out of a sprayer to propel the autonomous decoy device on the surface of a body of water. However, in other embodiments where the autonomous decoy device is land-based such as, but not limited to, using autonomous geese decoys or autonomous turkey decoys while hunting in a field, the propulsion system may be a motor in conjunction with a gear mechanism and wheels or robotic members to move the autonomous decoy device in a manner to attract game.

Several autonomous routines may be employed by the autonomous decoy device such as, but not limited to, a pinwheel free swim routine, a double-L free swim routine, an unstuck routine, and a converge routine. However, as would be obvious to one of skill in the art with the benefit of this disclosure, an enormous number of autonomous routines may be performed by the autonomous decoy device.

In one method of using the autonomous decoy device, at lease one autonomous decoy device is placed along with a beacon. One or more autonomous decoy devices are allowed to move autonomously within a specific range of the beacon. The specific range may be modified depending on size of the hunting area and desired decoy spread. At the end of the hunting session, the one or more autonomous decoys are signaled to converge to the beacon.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

As used herein, the term “transceiver” refers to any device that can one or both transmit and receive electromagnetic signals.

### Embodiments of an Autonomous Decoy Device

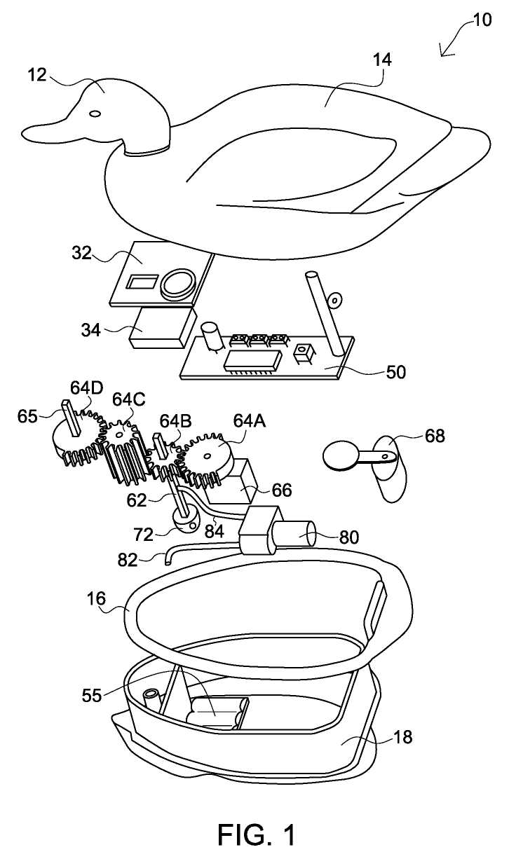

FIG. 1 shows one embodiment of an autonomous decoy device 10 with a breakout of its key components. The autonomous decoy device 10 comprises a head 12 that is mechanically coupled to a body 14. The head 12 is capable of turning independently of the body 14. In the embodiment of FIG. 1, the head 12 and body 14 are that of a duck decoy swimming on a body of water, however, numerous other decoys are contemplated for autonomous movement on a body of water or on land under the present invention. The body 14 is mechanically coupled to a frame 16 and the frame 16 is coupled to a hull 18. In the embodiment shown on FIG. 1, the head 12, the body 14, the frame 16 and the hull 18 are mechanically coupled to be buoyant and substantially watertight to protect the electronics and components therein.

Still referring to FIG. 1, a printed circuit board (PCB) assembly 50 comprises electronic circuitry for the operation of the autonomous decoy device 10. A cover 32 and a rubber seal 34 protect the PCB assembly 50 and its components. The PCB assembly 50 is electrically coupled to a battery 55, which provides power for the various components of the autonomous decoy device 10. The battery 55 may be of a disposable type such as zinc-carbon and alkaline batteries, or a rechargeable battery such as, but not limited to, a nickel-metal hydride (NiMH) battery. While the type of power source used in the autonomous decoy is not limiting to the invention, the NiMH battery typically provides more power for lengthy uses while hunting.

The PCB assembly 50 is electrically coupled to a servo 66; a shaker assembly 68; and a pump 80. A shaft within the servo 66 can be positioned to specific angular positions by sending the servo coded signals from the PCB assembly 50. When the appropriate signal sent by the PCB assembly 50 is received, the shaker assembly 68 will provide movement emulating the shaking activity of a duck or other waterfowl. The shaker assembly 68 may be a motor with a swinging counterweight as shown, but may also comprise any number of similar devices that is adapted to emulate the shaking of a duck or other waterfowl. The pump 80 can be any type of that can pump water, but in one embodiment, it is a gear pump. The pump 80 serves as the propulsion mechanism for the autonomous decoy device 10 and operates in conjunction with other steering components to direct the movement thereof.

Two elongated shafts direct movement to the autonomous decoy device 10. A first elongated shaft 62 is used to direct the propulsion system. A second elongated shaft 65 is used to turn the head 12 to simulate lifelike movement. A top end of the second elongated shaft 65 is mechanically coupled to the head 12. The head 12 rotates when the second elongated shaft 65 is rotated along its vertical axis. A bottom end of the first elongated shaft 62 is mechanically coupled to a sprayer 72 (also considered a nozzle or jet), which extends from the bottom of the hull 18. The portion from the hole of the first elongated shaft 62 to the sprayer 72 is hollow to allow water to flow through the lower portion of the first elongated shaft 62 and out a hole in the sprayer 72.

The pump 80 operates with the aid of two flexible tubes. Water from body of water on which the autonomous decoy device 10 is present may be drawn to the input of the pump 80 by a first flexible tube 82 whereby a first end of the first flexible tube is connected to a hole in the hull 18 and a second end of the first flexible tube is connected to the input of the pump 80. A filter is typically used in conjunction with the first flexible tube 82 in order to prevent or minimize the amount impediments from entering the pump 80. A first end of a second flexible tube 84 is connected to the output of the pump 80 and a second end of the second flexible tube 84 is coupled to a hole in the first elongated shaft 62. Movement of the autonomous decoy device 10 is achieved when water from the first flexible tube 82 is drawn into the pump 80 through a suction force created by the input of the pump 80 and pushed out the output of the pump 80 through the second flexible tube 84 into a hole in the first elongated shaft and out of the hole in the sprayer 72.

The direction for which the sprayer 72 is aimed at any given moment is controlled by the PCB assembly 50 and its signals sent to the servo 66. Signals are sent by the PCB assembly 50 to the servo 66 that instruct the servo 66 to rotate its internal shaft clockwise or counterclockwise to a specific angle from a neutral position. In one embodiment, the specific angle to be provided by the servo 66 is determined by the duration of pulses in the signal sent by the PCB assembly 50. The servo 66 typically expects to see a pulse every 20 milliseconds for the PCB assembly and the length of the pulse will determine how far the motor of the servo 66 turns internal shaft. However, as would be obvious to one of skill in the art, different types of servos may be employed in the present invention that do not rely on a pulse coded modulation technique.

As depicted in FIG. 1, the direction of the sprayer 72 is controlled by the first elongated shaft 62, which is moved with the servo 66. The servo 66 is mechanically coupled to the first elongated shaft 62 and the second elongated shaft 65 by a plurality of gears. Gear 64a is coupled to the internal shaft of the servo 66 having the center of gear 64a around the exterior of the internal shaft of the servo 66 and generally perpendicular to the longitudinal axis of the internal shaft of the servo 66. Gear 64b is coupled to the first elongated shaft 62 having the center of gear 64b around the exterior of the first elongated shaft 62 and generally perpendicular to the longitudinal axis of the first elongated shaft 62. The gear teeth of gear 64a mesh with the gear teeth of gear 64b in order to rotate the first elongated shaft 62 when the internal shaft of the servo 66 rotates.

The gear teeth of gear 64c mesh with the gear teeth of gear 64b. Additionally, the gear teeth of gear 64c mesh with the gear teeth of gear 64d. Gear 64d is coupled to the second elongated shaft 65 having the center of gear 64d around the exterior of the second elongated shaft 65 and generally perpendicular to the longitudinal axis of the second elongated shaft 65. Thus, when the servo 66 is directed to move by the microcontroller 56, the first elongated shaft 62 also rotates thereby rotating the sprayer 72 and the second elongated shaft 65 rotates the head 12. It is to be appreciated that the plurality of gears provides different gearing ratios to control the movements of the autonomous decoy device 10. For instance, a 90° rotation of the internal shaft of the servo 66 will result in a 135° rotation the first elongated shaft 62 and sprayer 72; and a 120° rotation the second elongated shaft 65 and the head 12.

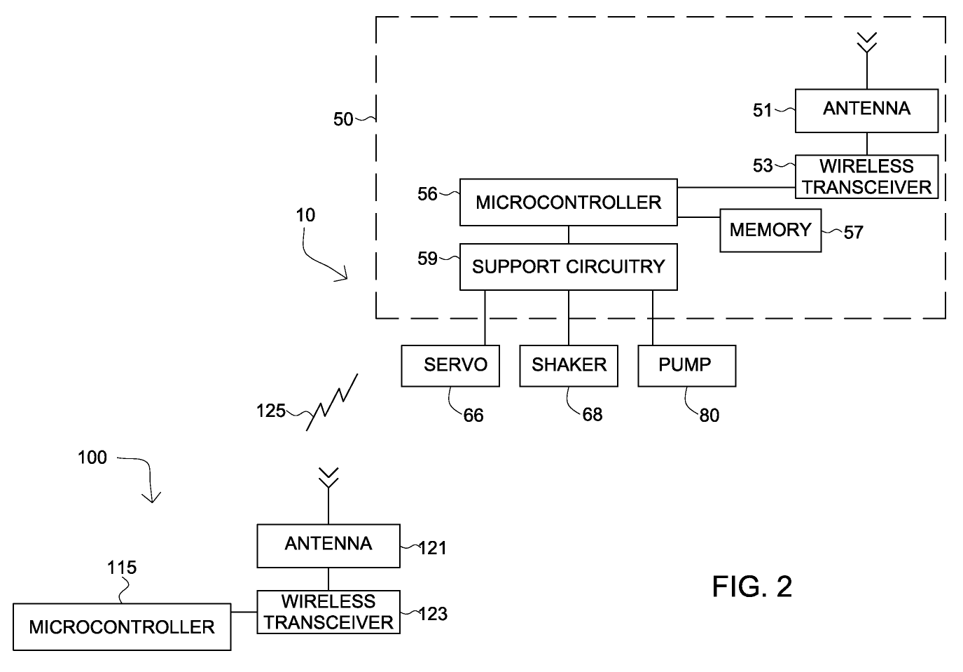

FIG. 2 is a schematic diagram of the autonomous decoy device 10 and a beacon 100. The PCB assembly 50 comprises control circuitry that allows the autonomous decoy device 10 to operate autonomously. The PCB assembly 50 includes a microcontroller 56, memory 57, a wireless transceiver 53 (or simply a receiver in some variations), an antenna 51, support circuitry 59, and one or more bus lines for providing electrical signals therebetween. In one embodiment, the wireless transceiver 53, microcontroller 56, and memory 57 may be combined on a single integrated chip, such as but not limited to, a Freescale Semiconductor MC1231x ZigBee™—Compliant Platform −2.4 GHz Low Power Transceiver for IEEE 802.15.4 Standard plus Microcontroller.

The microcontroller 56 utilizes programs and routines stored in memory 57 to control the movements of the autonomous decoy device 10. Registers are provided in memory 57 and accessible by the microcontroller 56 for comparison current and previous stored values. In one embodiment, at least five registers, R_{A}, R_{B}, R_{C}, R_{D}, and R_{E}, will exist whereby R_{A} contains the most current value and R_{E} contains the value from the fourth precious reading. However, more that five registers may typically exist as they are useful for troubleshooting and diagnosing the autonomous movements of the autonomous decoy device 10. As will be clear later in the specification, the registers and the values stored therein play a critical role in the logic used to determine the autonomous movements instructed by the microprocessor 56.

Through support circuitry 59, one or more bus lines, and/or one or more conductive wires, the microcontroller 56 delivers signals to the servo 66, the shaker assembly 68, and the pump 80. The programs and routines run by the microcontroller 56 perform various tasks such as, but not limited to, an autonomous pinwheel free swim routine, an autonomous double-L free swim routine, an autonomous unstuck routine, and an autonomous converge routine. In some embodiments, the microcontroller 56 utilizes various sensor readings to enable the autonomous decoy device 10 to detect obstacles and make evasive movements to avoid a collision.

Still referring to FIG. 2, the beacon 100 includes a microcontroller 115, a wireless transceiver 123, and an antenna 121. The beacon 100 generates a wireless reference signal 125 from its antenna 121 for which the autonomous decoy device 10 receives via its antenna 51 and utilizes in its microcontroller 56 logic. In operation, one or more autonomous decoy devices 10 may utilize the same beacon 100 and wireless reference signal 125. Furthermore, a plurality of beacons 100 and autonomous decoy devices 10 may be utilized within a close proximity of each other as the beacon can be made to transmit a unique wireless reference signal 125 to which only certain “slave” autonomous decoy devices 10 will respond.

Link quality measurements are taken by the autonomous decoy device 10 by measuring the signal power of the wireless reference signal 125. The antenna 51 receives the wireless reference signal 125. The wireless transceiver 53 measures its signal power and decodes any information provided therein. The microcontroller 56 receives the value of the link quality measurement (typically, but not necessarily provided in dBm units) as well as any information or message that was encoded within the wireless reference signal 125. The values of the link quality measurements taken at various time periods are stored in the aforementioned registers.

Referring to FIGS. 1 & 2, several of the autonomous movements of the autonomous decoy device 10 will be described. These movements will be identified throughout the specification relating to the various programs and routines executed by the microcontroller 56 and performed by various electromechanical component of the autonomous decoy device 10.

It is to be appreciated that variations to the following movements have been contemplated and developed such as, but not limited to, incorporating a compass reading into the microcontroller 56 logic to make more precise turns and incorporating a wind gauge reading into the microcontroller 56 whereby a longer activation period by the pump 80 will be instructed by the microcontroller 56 if the autonomous decoy device 10 is headed into the wind.

In one embodiment, to execute a forward movement, the microcontroller 56 first validates that the servo 66 is in a neutral position meaning the head 12 is looking straight forward and the hole in the sprayer 72 is pointing straight back to the tail. Next, the microcontroller 56 instructs the pump 80 to activate for four seconds.

In one embodiment, to execute a 90° right turn movement, the microcontroller 56 first instruct the servo 66 to rotate counterclockwise approximately 60°. This results in the head 12 being turned approximately 80° to the right side of the autonomous decoy device 10 and the hole in the sprayer 72 is pointing approximately 90° to the left side. Next, the microcontroller 56 instructs the pump 80 to activate for two seconds. Then, the microcontroller 56 instructs the servo 66 to return to the neutral position.

In one embodiment, to execute a 135° right turn movement, the microcontroller 56 first instruct the servo 66 to rotate counterclockwise approximately 90°. This results in the head 12 being turned approximately 120° to the right side of the autonomous decoy device 10 and the hole in the sprayer 72 is pointing approximately 135° to the left side. Next, the microcontroller 56 instructs the pump 80 to activate for two seconds. Then, the microcontroller 56 instructs the servo 66 to return to the neutral position.

In one embodiment, to execute a 180° right turn movement or a reverse movement, the microcontroller 56 first instruct the servo 66 to rotate counterclockwise approximately 120°. This results in the head 12 being turned approximately 160° to the right side of the autonomous decoy device 10 and the hole in the sprayer 72 is pointing approximately 180° to the left side or straight forward. Next, the microcontroller 56 instructs the pump 80 to activate for two seconds. Then, the microcontroller 56 instructs the servo 66 to return to the neutral position.

In one embodiment, a shaker movement is executed when the microcontroller 56 instructs the shaker assembly 68 to activate for four seconds. In one embodiment, the shaker movement may be randomly executed by the microcontroller 56 during any autonomous free swim routine. However, the shaker movement may also be preprogrammed into an autonomous free swim routine at specific intervals. The shaking movement creates ripples or small waves on the body of water. This is desirable because it displays lifelike movement to approaching game flying overhead. The shaking movement has an added benefit in that it may also move otherwise still decoys used in the arranged decoy spread along with one or more autonomous decoy devices 10.

In one embodiment, a pause movement is executed when the microcontroller 56 temporarily halts the autonomous free swim routine for eight second after which the autonomous free swim routine continues from where it left off.

An autonomous unstuck routine is a way in which the autonomous decoy device 10 attempts to remove itself from a condition that prohibits further movement. As will be described in more detail later in the specification, four previous link quality measurements are compared with the most recent link quality measurement to determine if they are all within plus or minus 1 dBm of each other. If so, aggressive movements are performed in the autonomous unstuck routine to remove the autonomous decoy device from the movement restricting condition. It is to be appreciated that the use of plus or minus 1 dBm to determine whether the autonomous decoy device 10 has become stuck is in no way limiting and the value may be modified in certain embodiments.

In one embodiment, a converge routine is executed when the microcontroller 56 either receives a converge message from the beacon 100 or determines that the autonomous decoy device 10 has exceeded a maximum allowable distance from the beacon 100. The converge message is encoded within the wireless reference signal 125 transmitted from the beacon 100. A user must indicate to the beacon 100 that the converge message should be sent. This is accomplished by one of several methods such as, but not limited to, pressing a converge button on the beacon 100 or pressing a converge button on a remote control device controls the operation of the beacon.

It is to be appreciated that additional advanced features may be incorporated into some variations of the autonomous decoy devices 10 to more accurately resemble the behavior of real water fowl, such as a preening action, a shimmy action, a flapping of the wings action. Some variations may include advanced obstacle avoidance capabilities utilizing a sonar type avoidance mechanism or even a mechanical mechanism that changes the decoys swimming behavior when it collides with an obstacle.

Several types of autonomous free swim routines may be utilized by an autonomous decoy 10 such as, but not limited to, an autonomous pinwheel free swim routine, an autonomous double-L free swim routine, an autonomous fully random swim routine, and an autonomous semi-random free swim routine. The autonomous pinwheel free swim routine and autonomous double-L free swim routine will be described below.

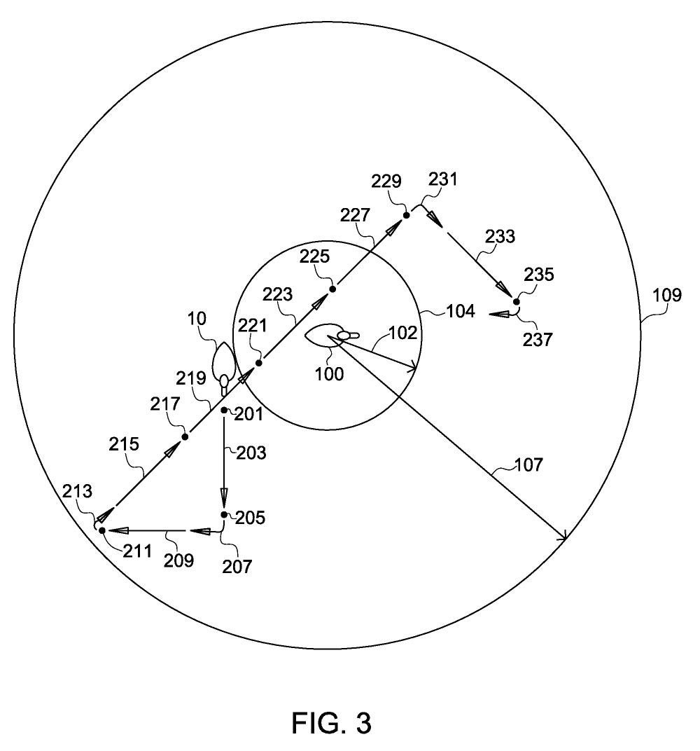

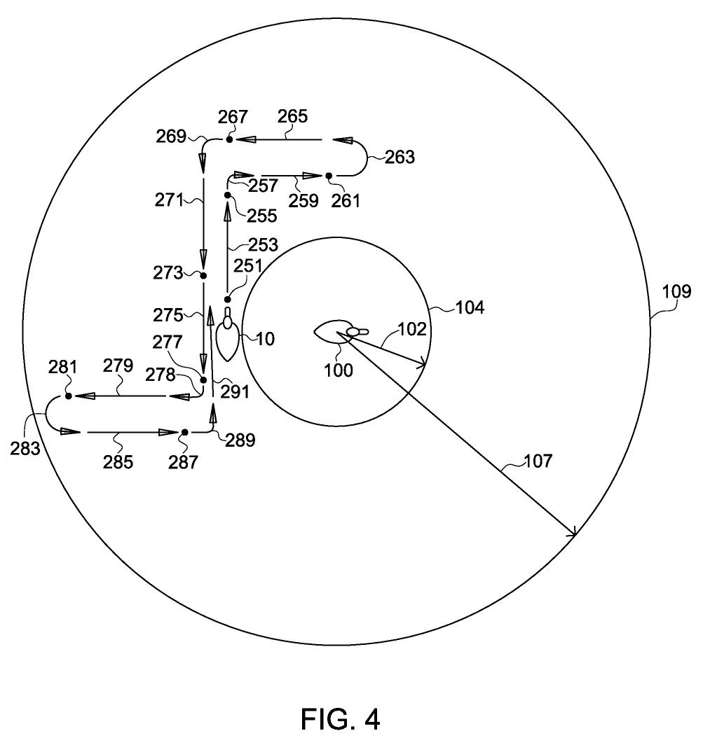

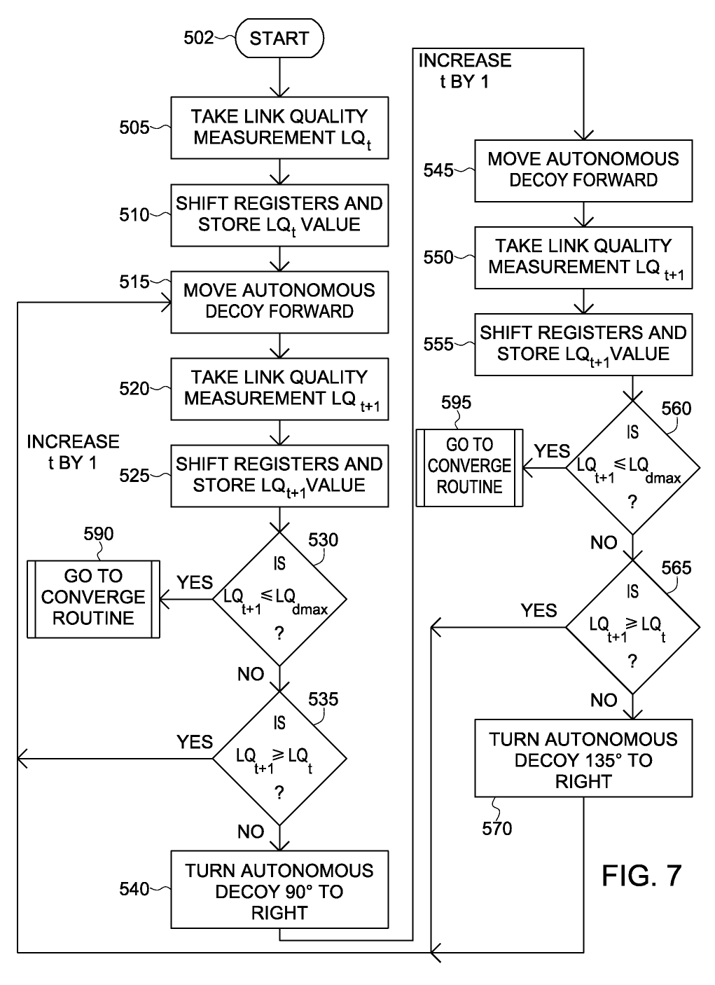

FIG. 3 is an overhead view showing a first autonomous free swim routine of the autonomous decoy device 10. The first autonomous free swim routine is designated as an autonomous pinwheel free swim routine and FIG. 7 is a flow chart illustrating the operation and algorithm used for the autonomous pinwheel free swim routine. Two concentric circles are identified in the overhead view of FIG. 3, as well as in the overhead views of FIGS. 4-6. These two concentric circles represent two different link quality values of the wireless reference signal 125 radiating from the beacon 100 depicted in the center of the two concentric circles. Signal power of the wireless reference signal 125 is diminished by geometric spreading of the wavefront and is attenuated the further from it gets from the beacon 100. As shown in the overhead views, the beacon 100 can be contained within a master decoy. The master decoy can be a remote controlled device or a stationary unit tethered in some form. However, the beacon 100 need not be in the form of a decoy and may take many different shapes and forms.

When the antenna 121 is a 360° omni-directional antenna as described in the current embodiment, the wireless reference signal 125 creates a generally circular wave dispersion. In variations and alternate embodiments, other types of antennas such as, but not limited to, a 70° directional antenna may be utilized to create a variety of wave dispersions and resulting decoy spreads. The converge circle 104 in the current embodiment is created by a converge radius 102. The converge radius 102 represents a distance at which the link quality measurement equals a specific signal power value. Similarly, a maximum distance circle 109 is created by a maximum distance radius 107. The maximum distance radius 107 represents a distance at which the link quality measurement equals a specific signal power. Also pertinent to note here is that the microcontroller 56 may instruct the autonomous decoy device 10 to shut down in an effort to preserve battery life if the signal power value reaches a significantly low level for a series of successive link quality measurements.

For illustrative purposes, in an embodiment utilizing a 2.4 GHz low power transceiver in the beacon 100, if the converge radius 102 is desired to be approximately 3 feet, a corresponding link quality measurement of −40 dBm may be coded in the algorithms of the microcontroller 56 for use in the autonomous decoy device 10. Furthermore, if the maximum distance radius 107 is desired to be approximately 30 feet, a corresponding link quality measurement of −60 dBm may be coded in the algorithms of the microcontroller 56 for use in the autonomous decoy device 10.

Referring now to both the overhead view of FIG. 3 and the flow chart of FIG. 7, exemplary movements of the autonomous decoy device 10 during the pinwheel free swim routine may be demonstrated. A variable t represents an instance in time at which a link quality (LQ) measurement is taken. In the following example, the variable t will equal 1 at the beginning of the algorithm meaning that the first link quality measurement during the pinwheel free swim algorithm will be the first link quality measurement taken by the microcontroller 56. However, it is worthy to note that variable t may begin with a greater value at the start of the pinwheel free swim routine. For instance, after an autonomous unstuck routine has been successfully completed, the variable t may equal 25, 40, or any of a wide range of numbers at the start of the pinwheel free swim routine. Alternatively, the variable t may be reset to 1 or another specific value at the beginning of the pinwheel free swim algorithm.

At the start of the algorithm represented by the flow chart (block 502), the autonomous decoy device 10 is located approximately at point 201. As indicated in block 505, a link quality measurement is taken. The value of the link quality measurement taken at point 201 is LQ₁. Next, the registers are shifted and the link quality value is stored in the register representing the most current reading (block 510). Hence, R_{A} will contain LQ₁; R_{B} will contain a null or default value; R_{C} will contain a null or default value; etc. Next, as indicated in block 515, the autonomous decoy device 10 is instructed to move forward. Thus, the autonomous decoy device 10 executes a forward movement 203. As indicated in block 520, another link quality measurement is taken. The value of the link quality measurement taken at point 205 is LQ₂. Next, the registers are shifted and the link quality value is stored in the register representing the most current reading (block 525). Hence, R_{A} will contain LQ₂; R_{B} will contain LQ₁; R_{C} will contain a null or default value; etc.

Next, as indicated in decision block 530, the microcontroller 56 compares the value of the most current link quality measurement with the link quality value of the maximum allowable distance (LQ_{dmax}) from the beacon 100. Here, as can be perceived from observing the two distances identified in the overhead view, point 205 is inside of the maximum distance circle 109. Thus, the signal power value represented by LQ₂ will be greater than LQ_{dmax} and the result of decision block 530 will be “no.” Decision block 530 (and similar decision blocks hereinafter) whereby the value of the most current link quality measurement is compared with LQ_{dmax} essentially is a check to ensure that the autonomous movements and external motion factors such as wind, and water currents have not taken the autonomous decoy device 10 out of the allowable range of the beacon 100. If the answer to decision block 530 had been “yes,” the free swim routine would be interrupted and the microcontroller 56 would go to the converge routine (block 590).

After determining that the autonomous decoy device 10 has not exceeded the maximum distance circle 109, the microcontroller 56 compares the value of the most current link quality measurement with the value of the previous link quality measurement (decision block 535). Here, as can be perceived from observing the two distances identified in the overhead view, point 205 is farther from the beacon 100 than point 201. Thus, the signal power value represented by LQ₂ will be less than LQ₁ and the result of decision block 535 will be “no.”

Next, as indicated in block 540, the autonomous decoy is instructed to turn 90° to the right. Thus, the autonomous decoy device 10 executes a 90° right turn movement 207. As instructed in the connector from block 540 to block 545, the variable t is increased by 1. Next, as indicated in block 545, the autonomous decoy device 10 is instructed to move forward. Thus, the autonomous decoy device 10 executes a forward movement 209. Next, as indicated in block 550, another link quality measurement is taken. The value of the link quality measurement taken at point 211 is LQ₃. Next, the registers are shifted and the link quality value is stored in the register representing the most current reading (block 555). Hence, R_{A} will contain LQ₃; R_{B} will contain LQ₂; R_{C} will contain LQ₁; etc.

Next, as indicated in decision block 560, the microcontroller 56 compares the value of the most current link quality measurement with the link quality value of the maximum allowable distance (LQ_{dmax}) from the beacon 100. Here, as can be perceived from observing the two distances identified in the overhead view, point 211 is inside of the maximum distance circle 109 albeit very close. Thus, the signal power value represented by LQ₃ will be greater than LQ_{dmax} and the result of decision block 560 will be “no.” Note that as previously described, if the answer to decision block 560 had been “yes,” the free swim routine would be interrupted and the microcontroller 56 would go to the converge routine (block 595).

After determining that the autonomous decoy device 10 has not exceeded the maximum distance circle 109, the microcontroller 56 compares the value of the most current link quality measurement with the value of the previous link quality measurement (decision block 565). Here, as can be perceived from observing the two distances identified in the overhead view, point 211 is farther from the beacon 100 than point 205. Thus, the signal power value represented by LQ₃ will be less than LQ₂ and the result of decision block 565 will be “no.”

Next, as indicated in block 570, the autonomous decoy is instructed to turn 135° to the right. Thus, the autonomous decoy device 10 executes a 135° right turn movement 213. This type of sharp turn is executed because the microcontroller 56 senses that the autonomous decoy device 10 is moving farther from the beacon 100 even after previously executing a 90° right turn movement. Hence, the sharper 135° right turn movement in the pinwheel free swim routine at this stage in the algorithm is a way to bring the autonomous decoy device 10 back toward the beacon 100 and avoid going outside of the maximum distance circle 109.

Next, the algorithm defining the pinwheel free swim routine will loop back to block 515. As instructed in the loop back connector from block 570 to block 515, the variable t is increased by 1. As indicated in block 515, the autonomous decoy device 10 is instructed to move forward. Thus, the autonomous decoy device 10 executes a forward movement 215. Next, as indicated in block 520, a link quality measurement is taken. The value of the link quality measurement taken at point 217 is LQ₄. Next, the registers are shifted and the link quality value is stored in the register representing the most current reading (block 525). Hence, R_{A} will contain LQ₄; R_{B} will contain LQ₃; R_{C} will contain LQ₂; etc.

At this time in the algorithm it is appropriate to introduce the shaker movement to the pinwheel free swim routine. As previously described, the shaker movement may be randomly executed during any free swim routine. Taking point 217 as the position when the microcontroller 56 randomly determines to execute the shaker movement, the pinwheel free swim routine is temporarily interrupted and the shaker movement executed by the autonomous decoy device 10.

Returning back to the pinwheel free swim routine, as indicated in decision block 530, the microcontroller 56 compares the value of the most current link quality measurement with the link quality value of the maximum allowable distance (LQ_{dmax}) from the beacon 100. Here, as can be perceived from observing the two distances identified in the overhead view, point 217 is inside of the maximum distance circle 109. Thus, the signal power value represented by LQ₄ will be greater than LQ_{dmax} and the result of decision block 530 will be “no.”

After determining that the autonomous decoy device 10 has not exceeded the maximum distance circle 109, the microcontroller 56 again compares the value of the most current link quality measurement with the value of the previous link quality measurement (decision block 535). Here, as can be perceived from observing the two distances identified in the overhead view, point 217 is closer to the beacon 100 than point 211. Thus, the signal power value represented by LQ₄ will be greater than LQ₃ and the result of decision block 535 will be “yes.” Here, the algorithm defining the pinwheel free swim routine will loop back to block 515 again. As instructed in the connector from decision block 535 to block 515, the variable t is increased by 1.

Next, as indicated in block 515, the autonomous decoy device 10 is instructed to move forward. Thus, the autonomous decoy device 10 executes a forward movement 219. Next, as indicated in block 520, a link quality measurement is taken. The value of the link quality measurement taken at point 221 is LQ₅. Next, the registers are shifted and the link quality value is stored in the register representing the most current reading (block 525). Hence, R_{A} will contain LQ₅; R_{B} will contain LQ₄; R_{C} will contain LQ₃; etc.

Next, as indicated in decision block 530, the microcontroller 56 compares the value of the most current link quality measurement with the link quality value of the maximum allowable distance (LQ_{dmax}) from the beacon 100. Here, as can be perceived from observing the two distances identified in the overhead view, point 221 is clearly inside of the maximum distance circle 109; in fact, it is even inside the converge circle 104. Thus, the signal power value represented by LQ₅ will be greater than LQ_{dmax} and the result of decision block 530 will be “no.” After determining that the autonomous decoy device 10 has not exceeded the maximum distance circle 109, the microcontroller 56 compares the value of the most current link quality measurement with the value of the previous link quality measurement (decision block 535). Once again, as can be perceived from observing the two distances identified in the overhead view, point 221 is closer to the beacon 100 than point 217. Thus, the signal power value represented by LQ₅ will be greater than LQ₄ and the result of decision block 535 will be “yes.” Here again, the algorithm defining the pinwheel free swim routine will loop back to block 515. Further, as instructed in the connector from decision block 535 to block 515, the variable t is increased by 1.

For orientation purposes, the variable t equals 5 at this stage of the algorithm. However, since the forthcoming instruction in block 520 will be to take the link quality measurement LQₜ₊1, the next link quality measurement will be LQ₆. Next, as indicated in block 515, the autonomous decoy device 10 is instructed to move forward. Thus, the autonomous decoy device 10 executes a forward movement 223. Next, as indicated in block 520, a link quality measurement is taken. As eluded to, the value of the link quality measurement taken at point 225 is LQ₆. Next, the registers are shifted and the link quality value is stored in the register representing the most current reading (block 525). Hence, R_{A} will contain LQ₆; R_{B} will contain LQ₅; R_{C} will contain LQ₄; etc.

Next, as indicated in decision block 530, the microcontroller 56 compares the value of the most current link quality measurement with the link quality value of the maximum allowable distance (LQ_{dmax}) from the beacon 100. Here, as can be perceived from observing the two distances identified in the overhead view, point 225 is inside of the maximum distance circle 109. Thus, the signal power value represented by LQ₆ will be greater than LQ_{dmax} and the result of decision block 530 will be “no.” After determining that the autonomous decoy device 10 has not exceeded the maximum distance circle 109, the microcontroller 56 compares the value of the most current link quality measurement with the value of the previous link quality measurement (decision block 535). Here, as can be perceived from observing the two distances identified in the overhead view, point 225 is closer to the beacon 100 than point 221. Thus, the signal power value represented by LQ₆ will be greater than LQ₅ and the result of decision block 535 will be “yes.” Again, the algorithm defining the pinwheel free swim routine will loop back to block 515. Further, as instructed in the connector from decision block 535 to block 515, the variable t is increased by 1.

Next, as indicated in block 515, the autonomous decoy device 10 is instructed to move forward. Thus, the autonomous decoy device 10 executes a forward movement 227. Next, as indicated in block 520, a link quality measurement is taken. The value of the link quality measurement taken at point 229 is LQ₇. Next, the registers are shifted and the link quality value is stored in the register representing the most current reading (block 525). Hence, R_{A} will contain LQ₇; R_{B} will contain LQ₆; R_{C} will contain LQ₅; etc. Next, as indicated in decision block 530, the microcontroller 56 compares the value of the most current link quality measurement with the link quality value of the maximum allowable distance (LQ_{dmax}) from the beacon 100. Here, as can be perceived from observing the two distances identified in the overhead view, point 229 is inside of the maximum distance circle 109. Thus, the signal power value represented by LQ₇ will be greater than LQ_{dmax} and the result of decision block 530 will be “no.”

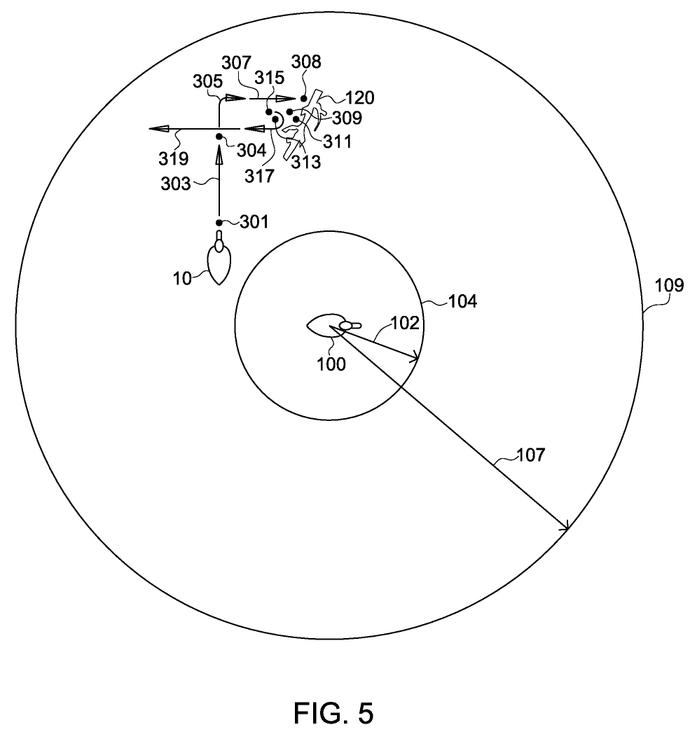

Subsequent to determining that the autonomous decoy device 10 has not exceeded the maximum distance circle 109, the microcontroller 56 compares the value of the most current link quality measurement with the value of the previous link quality measurement (decision block 535). As can be perceived from observing the two distances identified in the overhead view, point 229 is farther from the beacon 100 than point 225. Thus, the signal power value represented by LQ₇ will be less than LQ₆ and the result of decision block 535 will be “no.” As can be seen from the overhead view of FIG. 3, the previous points 211, 217, 221, and 225 have been moving closer to the beacon 100; however, point 229 changes that pattern and is farther from the beacon than the previous point 225. As such, the next instruction on the flow chart of FIG. 5 is block 540. As indicated in block 540, the autonomous decoy is instructed to turn 90° to the right. Thus, the autonomous decoy device 10 executes a 90° right turn movement 231. As instructed in the connector from block 540 to block 545, the variable t is increased by 1.

Next, as indicated in block 545, the autonomous decoy device 10 is instructed to move forward. Thus, the autonomous decoy device 10 executes a forward movement 233. Next, as indicated in block 550, a link quality measurement is taken. The value of the link quality measurement taken at point 235 is LQ₈. Next, the registers are shifted and the link quality value is stored in the register representing the most current reading (block 555). Hence, R_{A} will contain LQ₈; R_{B} will contain LQ₇; R_{C} will contain LQ₆; etc.

Next, as indicated in decision block 560, the microcontroller 56 compares the value of the most current link quality measurement with the link quality value of the maximum allowable distance (LQ_{dmax}) from the beacon 100. Here, as can be perceived from observing the two distances identified in the overhead view, point 235 is inside of the maximum distance circle 109. Thus, the signal power value represented by LQ₈ will be greater than LQ_{dmax} and the result of decision block 560 will be “no.” After determining that the autonomous decoy device 10 has not exceeded the maximum distance circle 109, the microcontroller 56 compares the value of the most current link quality measurement with the value of the previous link quality measurement (decision block 565). Here, as can be perceived from closely observing the two distances identified in the overhead view, point 235 is slightly farther from the beacon 100 than point 229. Thus, the signal power value represented by LQ₈ will be slightly less than LQ₇ and the result of decision block 565 will be “no.” In an instance where the result of decision block 565 is “yes,” the flow chart loops back to block 515 and, as instructed in the connector from decision block 565 to block 515, the variable t would be increased by 1. However, since the answer to decision block 565 is “no,” the flow chart moves to block 570. As indicated in block 570, the autonomous decoy is instructed to turn 135° to the right. Thus, the autonomous decoy device 10 executes a 135° right turn movement 237.

Next, as instructed in the connector from block 570 to block 515, the variable t is increased by 1. As can be seen and has been fully described, the pinwheel free swim routine provides autonomous movement within a specific range and continues in perpetuity until an event causes the autonomous decoy device 10 to cease operating the free swim routine.

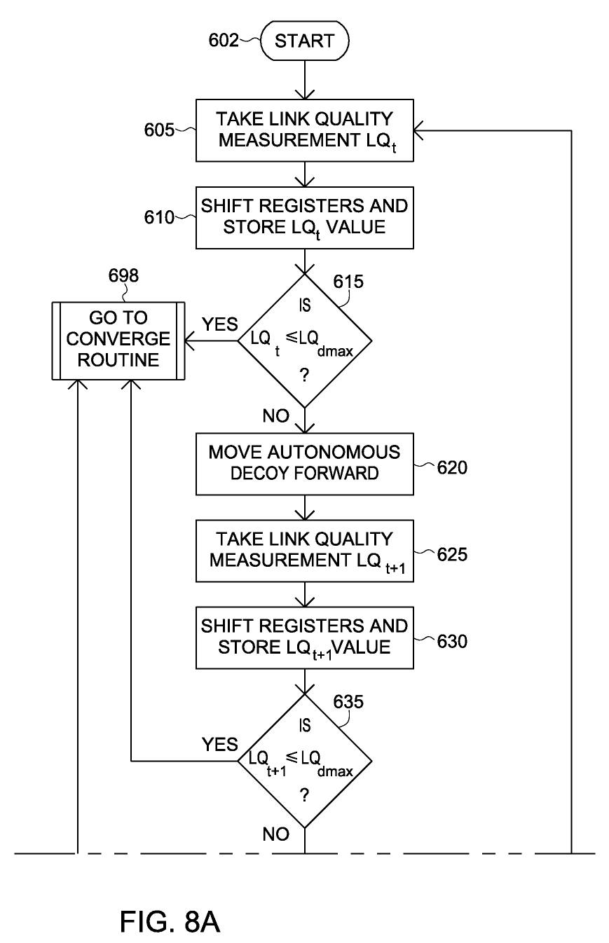

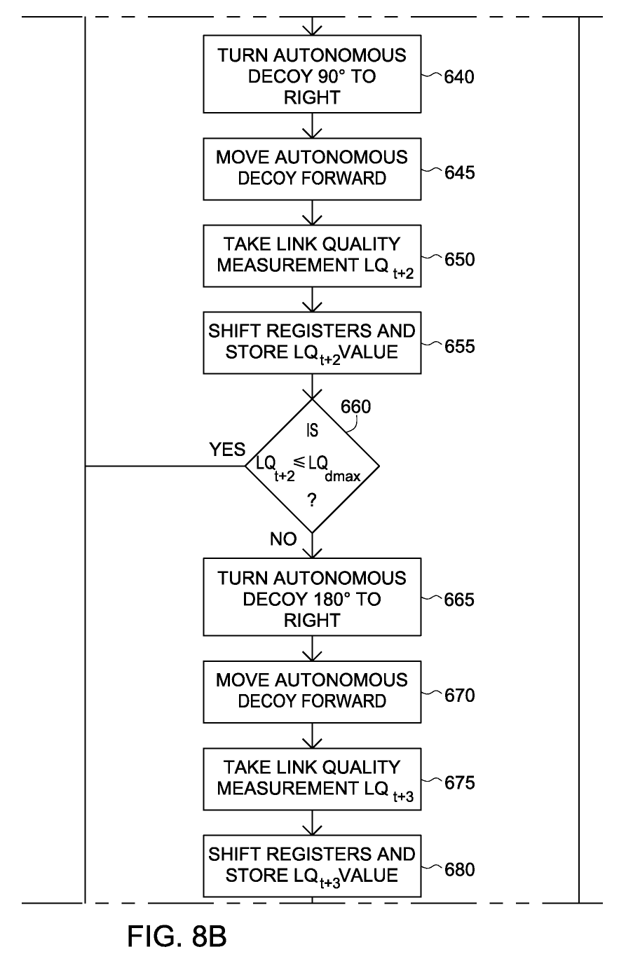

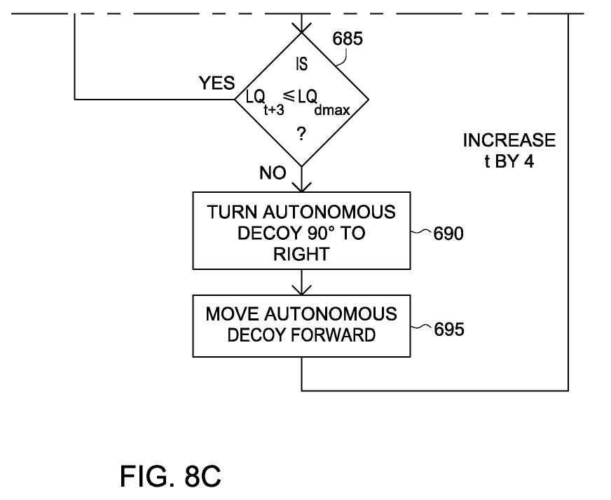

FIG. 4 is an overhead view showing a second autonomous free swim routine of the autonomous decoy device 10. The second autonomous free swim routine is designated as a double-L free swim routine. FIG. 8 is a flow chart illustrating the operation and algorithm used for the double-L free swim routine. The various instructions and operations of the double-L free swim routine illustrated in FIG. 8 are divided between FIGS. 8A, 8B, & 8C; however, this division is done solely due to the size of the flow chart and not intended to represent any relevant delineation.

Referring now to both the overhead view of FIG. 4 and the flow chart of FIG. 8, exemplary movements of the autonomous decoy device 10 during the double-L free swim routine may be demonstrated. In the following example, the variable t will equal 17 at the beginning of the algorithm meaning that it is not the first link quality measurement during the double-L free swim routine. Starting the exemplary movements with the variable t at 17 is not in anyway limiting, but is merely suggestive of the third cycle of the double-L free swim routine and useful to avoid confusion with other routines described in this specification.

At the start of the algorithm represented by the flow chart (block 602), the autonomous decoy device 10 is located approximately at point 251. As indicated in block 605, a link quality measurement is taken. The value of the link quality measurement taken at point 251 is LQ₁₇. Next, the registers are shifted and the link quality value is stored in the register representing the most current reading (block 610). Hence, R_{A} will contain LQ₁₇; R_{B} will contain LQ₁₆; R_{C} will contain LQ₁₅; etc.

Next, as indicated in decision block 615, the microcontroller 56 compares the value of the most current link quality measurement with the link quality value of the maximum allowable distance (LQ_{dmax}) from the beacon 100. Here, as can be perceived from observing the two distances identified in the overhead view, point 251 is inside of the maximum distance circle 109. Thus, the signal power value represented by LQ₁₇ will be greater than LQ_{dmax} and the result of decision block 615 will be “no.” It is worthy to note that if the answer to decision block 615 had been “yes,” the double-L free swim routine would be interrupted and the microcontroller 56 would go to the converge routine (block 698).

Next, as indicated in block 620, the autonomous decoy device 10 is instructed to move forward. Thus, the autonomous decoy device 10 executes a forward movement 253. Next, as indicated in block 625, a link quality measurement is taken. The value of the link quality measurement taken at point 255 is LQ₁₈. Next, the registers are shifted and the link quality value is stored in the register representing the most current reading (block 630). Hence, R_{A} will contain LQ₁₈; R_{B} will contain LQ₁₇; R_{C} will contain LQ₁₆; etc.

Next, the question whether the maximum allowable distance has been exceeded by the autonomous decoy device 10 is analyzed with an answer of “no” to decision block 635. Please note that having fully described maximum allowable distance inquiry, this repetitive decision block of the double-L free swim routine will be abbreviated hereinafter. Next, as indicated in block 640, the autonomous decoy is instructed to turn 90° to the right. Thus, the autonomous decoy device 10 executes a 90° right turn movement 257. Next, as indicated in block 645, the autonomous decoy device 10 is instructed to move forward. Thus, the autonomous decoy device 10 executes a forward movement 259.

Next, as indicated in block 650, a link quality measurement is taken. The value of the link quality measurement taken at point 261 is LQ₁₉. Next, the registers are shifted and the link quality value is stored in the register representing the most current reading (block 655). Hence, R_{A} will contain LQ₁₉; R_{B} will contain LQ₁₈; R_{C} will contain LQ₁₇; etc. Next, the question whether the maximum allowable distance has been exceeded by the autonomous decoy device 10 is analyzed with an answer of “no” to decision block 660.

Next, as indicated in block 665, the autonomous decoy is instructed to turn 180° to the right. Thus, the autonomous decoy device 10 executes a 180° right turn movement 263. Following the 180° right turn movement, as indicated in block 670, the autonomous decoy device 10 is instructed to move forward. Thus, the autonomous decoy device 10 executes a forward movement 265.

Next, as indicated in block 675, a link quality measurement is taken. The value of the link quality measurement taken at point 267 is LQ₂₀. Next, the registers are shifted and the link quality value is stored in the register representing the most current reading (block 680). Hence, R_{A} will contain LQ₂₀; R_{B} will contain LQ₁₉; R_{C} will contain LQ₁₈; etc. Next, the question whether the maximum allowable distance has been exceeded by the autonomous decoy device 10 is analyzed with an answer of “no” to decision block 685.

Next, as indicated in block 690, the autonomous decoy is instructed to turn 90° to the right. Thus, the autonomous decoy device 10 executes a 90° right turn movement 269. Next, as indicated in block 695, the autonomous decoy device 10 is instructed to move forward. Thus, the autonomous decoy device 10 executes a forward movement 271. As instructed in the connector from block 695 to block 605, the variable t is increased by 4. Thus, since the variable t was 17 at the start of the flow chart and it has not been increased beyond instructions indicating to link quality measurements of LQₜ₊₁, LQₜ₊₂, and LQₜ₊₃, the new value for the variable t will be 21 upon returning to block 605.

Next, as indicated in block 605, a link quality measurement is taken. The value of the link quality measurement taken at point 273 is LQ₂₁. Next, the registers are shifted and the link quality value is stored in the register representing the most current reading (block 610). Hence, R_{A} will contain LQ₂₁; R_{B} will contain LQ₂₀; R_{C} will contain LQ₁₉; etc. Next, the question whether the maximum allowable distance has been exceeded by the autonomous decoy device 10 is analyzed with an answer of “no” to decision block 615.

Next, as indicated in block 620, the autonomous decoy device 10 is instructed to move forward. Thus, the autonomous decoy device 10 executes a forward movement 275. Next, as indicated in block 625, a link quality measurement is taken. The value of the link quality measurement taken at point 277 is LQ₂₂. Next, the registers are shifted and the link quality value is stored in the register representing the most current reading (block 630). Hence, R_{A} will contain LQ₂₂; R_{B} will contain LQ₂₁; R_{C} will contain LQ₂₀; etc. Next, the question whether the maximum allowable distance has been exceeded by the autonomous decoy device 10 is analyzed with an answer of “no” to decision block 635.

Moving next to block 640, the autonomous decoy is instructed to turn 90° to the right. Thus, the autonomous decoy device 10 executes a 90° right turn movement 278. Next, as indicated in block 645, the autonomous decoy device 10 is instructed to move forward. Thus, the autonomous decoy device 10 executes a forward movement 279. Next, as indicated in block 650, a link quality measurement is taken. The value of the link quality measurement taken at point 281 is LQ₂₃. Next, the registers are shifted and the link quality value is stored in the register representing the most current reading (block 655). Hence, R_{A} will contain LQ₂₃; R_{B} will contain LQ₂₂; R_{C} will contain LQ₂₁; etc. Next, the question whether the maximum allowable distance has been exceeded by the autonomous decoy device 10 is analyzed, and although point 281 is rather close to the maximum distance circle 109, it is still an answer of “no” to decision block 660.

Next, as indicated in block 665, the autonomous decoy is instructed to turn 180° to the right. Thus, the autonomous decoy device 10 executes a 180° right turn movement 283. Next, as indicated in block 670, the autonomous decoy device 10 is instructed to move forward. Thus, the autonomous decoy device 10 executes a forward movement 285. Next, as indicated in block 675, a link quality measurement is taken. The value of the link quality measurement taken at point 287 is LQ₂₄. Next, the registers are shifted and the link quality value is stored in the register representing the most current reading (block 680). Hence, R_{A} will contain LQ₂₄; R_{B} will contain LQ₂₃; R_{C} will contain LQ₂₂; etc.

At this time in the algorithm it is appropriate to introduce the pause movement to the autonomous double-L free swim routine. As previously described, the pause movement may be randomly executed during any free swim routine. Taking point 287 as the position when the microcontroller 56 randomly determines to execute the pause movement, the autonomous double-L free swim routine is temporarily interrupted and the pause movement is executed by the autonomous decoy device 10.

Next, the question whether the maximum allowable distance has been exceeded by the autonomous decoy device 10 is analyzed with an answer of “no” to decision block 685. Next, as indicated in block 690, the autonomous decoy is instructed to turn 90° to the right. Thus, the autonomous decoy device 10 executes a 90° right turn movement 289. And finally to complete the double-L swim routine bringing the autonomous decoy device back to approximately where it started absent any environmental factors, as indicated in block 695, the autonomous decoy device 10 is instructed to move forward. Thus, the autonomous decoy device 10 executes a forward movement 291.

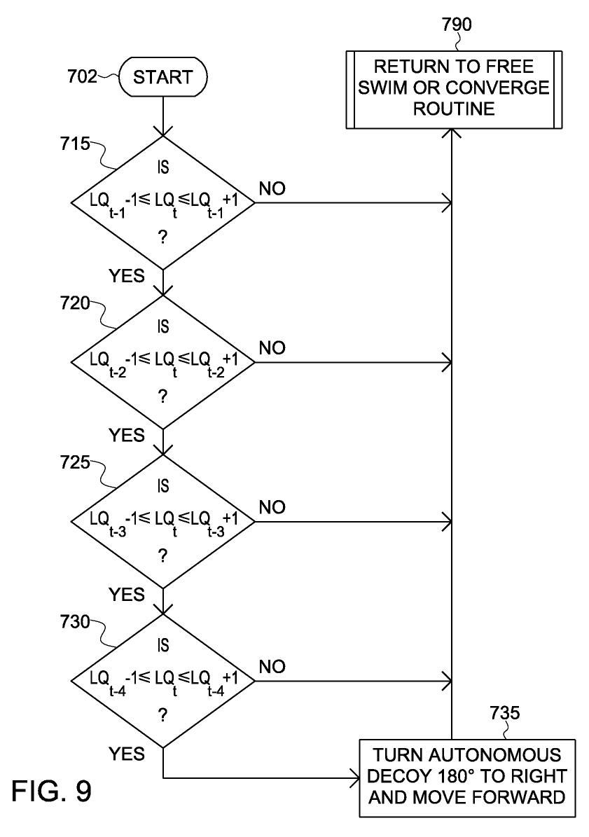

FIG. 5 is an overhead view showing an autonomous unstuck routine of the autonomous decoy device 10. An obstacle 120 is identified that will obstruct the autonomous motion of the autonomous decoy device 10. The obstacle may be an object such as, but not limited to, a fallen tree branch, a rock, a heavy growth of lily pads, and pond scum or other blooms of aquatic algae. FIG. 9 is a flow chart illustrating the operation and algorithm used for the autonomous unstuck routine of the autonomous decoy device 10. It is important to realize that at no time is any intervention by a user of the autonomous decoy device 10 required to initiate or assist in the operation to the autonomous unstuck routine. Furthermore, after a certain number of attempts executing the autonomous unstuck routine, the autonomous decoy device 10 will turn off to preserve battery life and avoid potential damage to its component in an apparently futile attempt of freeing itself from an obstruction.

First, it is helpful to understand that in one embodiment of the present invention, the autonomous unstuck routine runs coincident with the free swim and converge routines. Therefore, after every instance when a link quality measurement is taken followed by a shifting of the registers (two consecutive blocks that occur throughout the various flow charts), the microcontroller 56 temporarily suspends the free swim or converge routine to run the autonomous unstuck routine. Additionally, for the purposes of the autonomous unstuck routine, the variable t utilized for comparison in the decisions blocks represents the time of the most current link quality measurement taken. Hence, if during the double-L free swim routine the most current link quality measurement is described in the associated flow chart as LQₜ₊₂ where t equals 17 making the most current link quality measurement LQ₁₉; then, the corresponding value of the variable t equals 19 (the value of the most current link quality measurement) when referring to the autonomous unstuck routine described in the flow chart of FIG. 9.

Referring now to both the overhead view of FIG. 5 and the flow chart of FIG. 9, the autonomous unstuck routine may be demonstrated. In the following example, the variable t will equal 25 and begin with link quality measurement LQ₂₅. Starting the exemplary movements with the variable t at 25 is not in anyway limiting, but is merely suggestive of a continuation from the previous double-L free swim routine as the autonomous decoy device 10 enters its fourth cycle and is useful to avoid confusion with other routines described in this specification.

First, a link quality measurement is taken during the double-L free swim routine. The value of the link quality measurement taken at point 301 is LQ₂₅. Next, the registers are shifted and the link quality value is stored in the register representing the most current reading. Hence, R_{A} will contain LQ₂₅=−53.68 dBm; R_{B} will contain LQ₂₄=−55.02 dBm; R_{C} will contain LQ₂₃=−58.54 dBm; R_{D} will contain LQ₂₂=−52.92 dBm; R_{E} will contain LQ₂₁;=−49.79 dBm; etc. Note that for the purposes of describing the autonomous unstuck routine additional registers will be utilized along with example dBm values of the link quality measurements.

After the most current link quality measurement from the swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₂₅=−53.68 dBm is not within plus or minus 1 dBm of LQ₂₄=−55.02 dBm (i.e. between −56.02 dBm and −54.04 dBm); and the result of decision block 715 will be “no.” Thus, as indicated by the arrow on the flow chart, the microcontroller 56 will exit the autonomous unstuck routine and return to the free swim or converge routine from which it came (block 790).

Next, the autonomous decoy device 10 is instructed to move forward and executes a forward movement 303. Next, a link quality measurement is taken during the double-L free swim routine. The value of the link quality measurement taken at point 304 is LQ₂₆. Next, the registers are shifted and the link quality value is stored in the register representing the most current reading. Hence, R_{A} will contain LQ₂₆=−57.67 dBm; R_{B} will contain LQ₂₅=−53.68 dBm; R_{C} will contain LQ₂₄=−55.02 dBm; R_{D} will contain LQ₂₃=−58.54 dBm; R_{E} will contain LQ₂₂=−52.92 dBm; etc.

After the most current link quality measurement from the free swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₂₆=−57.67 dBm is not within plus or minus 1 dBm of LQ₂₅=−53.68 dBm (i.e. between −54.68 dBm and −52.68 dBm); and the result of decision block 715 will be “no.” Thus, as indicated by the arrow on the flow chart, the microcontroller 56 will exit the autonomous unstuck routine and return to the free swim or converge routine from which it came (block 790).

Next, the autonomous decoy is instructed to turn 90° to the right and executes a 900 right turn movement 305. Next, the autonomous decoy device 10 is instructed to move forward and executes a forward movement 307. However, full forward movement of the autonomous decoy device 10 is not achieved as it is encounters and becomes caught in the obstacle 120.

Nevertheless, the free swim routine continues and a link quality measurement is taken. The value of the link quality measurement taken at point 308 is LQ₂₇. Next, the registers are shifted and the link quality value is stored in the register representing the most current reading. Hence, R_{A} will contain LQ₂₇=−56.53 dBm; R_{B} will contain LQ₂₆=−57.67 dBm; R_{C} will contain LQ₂₅=−53.68 dBm; R_{D} will contain LQ₂₄=−55.02 dBm; R_{E} will contain LQ₂₃=−58.54 dBm; etc.

After the most current link quality measurement from the free swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₂₇=−56.53 dBm is not within plus or minus 1 dBm of LQ₂₆=−57.67 dBm (i.e. between −58.67 dBm and −56.67 dBm); and the result of decision block 715 will be “no.” Thus, as indicated by the arrow on the flow chart, the microcontroller 56 will exit the autonomous unstuck routine and return to the free swim or converge routine from which it came (block 790).

Next, another autonomous movement is attempted by the autonomous decoy device 10, but fails to a degree. However, another link quality measurement is taken. The value of the link quality measurement taken at point 309 is LQ₂₈. Next, the registers are shifted and the link quality value is stored in the register representing the most current reading. Hence, R_{A} will contain LQ₂₈=−56.62 dBm; R_{B} will contain LQ₂₇=−56.53 dBm; R_{C} will contain LQ₂₆=−57.67 dBm; R_{D} will contain LQ₂₅=−53.68 dBm; R_{E} will contain LQ₂₄=−55.02 dBm; etc.

Again after the most current link quality measurement from the free swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₂₈=−56.62 dBm is within plus or minus 1 dBm of LQ₂₇=−56.53 dBm (i.e. between −57.53 dBm and −55.53 dBm); and the result of decision block 715 will be “yes.” Next, the microcontroller 56 compares the value of the most current link quality measurement to determine if it is within plus or minus 1 dBm of the value of the link quality measurement taken two instances previous (decision block 720). Here, LQ₂₈=−56.62 dBm is not within plus or minus 1 dBm of LQ₂₆=−57.67 dBm (i.e. between −58.67 dBm and −56.67 dBm); and the result of decision block 720 will be “no.” Thus, as indicated by the arrow on the flow chart, the microcontroller 56 will exit the autonomous unstuck routine and return to the free swim or converge routine from which it came (block 790).

After another failed autonomous movement by the autonomous decoy device 10, another link quality measurement is taken. The value of the link quality measurement taken at point 311 is LQ₂₉. Next, the registers are shifted and the link quality value is stored in the register representing the most current reading. Hence, R_{A} will contain LQ₂₉=−56.18 dBm; R_{B} will contain LQ₂₈=−56.62 dBm; R_{C} will contain LQ₂₇=−56.53 dBm; R_{D} will contain LQ₂₆=−57.67 dBm; R_{E} will contain LQ₂₅=−53.68 dBm; etc.

Once again after the most current link quality measurement from the free swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₂₉=−56.18 dBm is within plus or minus 1 dBm of LQ₂₈=−56.62 dBm (i.e. between −57.62 dBm and −55.62 dBm); and the result of decision block 715 will be “yes.” Next, the microcontroller 56 compares the value of the most current link quality measurement to determine if it is within plus or minus 1 dBm of the value of the link quality measurement taken two instances previous (decision block 720). Here, LQ₂₉=−56.18 dBm is also within plus or minus 1 dBm of LQ₂₇=−56.53 dBm (i.e. between −57.53 dBm and −55.53 dBm); and the result of decision block 720 will be “yes.”

Following the arrow in the flowchart to the next decision block, the microcontroller 56 compares the value of the most current link quality measurement to determine if it is within plus or minus 1 dBm of the value of the link quality measurement taken three instances previous (decision block 725). Here, LQ₂₉=−56.18 dBm is not within plus or minus 1 dBm of LQ₂₆=−57.67 dBm (i.e. between −58.67 dBm and −56.67 dBm); and the result of decision block 725 will be “no.” Thus, as indicated by the arrow on the flow chart, the microcontroller 56 will exit the autonomous unstuck routine and return to the free swim or converge routine from which it came (block 790).

Next, another autonomous movement is attempted by the autonomous decoy device 10, but fails to some degree. The value of the link quality measurement taken at point 313 is LQ₃₀. Next, the registers are shifted and the link quality value is stored in the register representing the most current reading. Hence, R_{A} will contain LQ₃₀=56.36 dBm; R_{B} will contain LQ₂₉=−56.18 dBm; R_{C} will contain LQ₂₈=−56.62 dBm; R_{D} will contain LQ₂₇=−56.53 dBm; R_{E} will contain LQ₂₆=−57.67 dBm; etc.

After the most current link quality measurement from the free swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₃₀=−56.36 dBm is within plus or minus 1 dBm of LQ₂₉=−56.18 dBm (i.e. between −57.18 dBm and −55.18 dBm); and the result of decision block 715 will be “yes.” Next, the microcontroller 56 compares the value of the most current link quality measurement to determine if it is within plus or minus 1 dBm of the value of the link quality measurement taken two instances previous (decision block 720). Here, LQ₃₀=−56.36 dBm is also within plus or minus 1 dBm of LQ₂₈=−56.62 dBm (i.e. between −57.62 dBm and −55.62 dBm); and the result of decision block 720 will be “yes.” Next, the microcontroller 56 compares the value of the most current link quality measurement to determine if it is within plus or minus 1 dBm of the value of the link quality measurement taken three instances previous (decision block 725). Here, LQ₃₀=−56.36 dBm is again within plus or minus 1 dBm of LQ₂₇=−56.53 dBm (i.e. between −57.53 dBm and −55.53 dBm); and the result of decision block 725 will be “yes.”

Following the arrow to the next and final decision block, the microcontroller 56 compares the value of the most current link quality measurement to determine if it is within plus or minus 1 dBm of the value of the link quality measurement taken four instances previous (decision block 730). Here, LQ₃₀=−56.36 dBm is not within plus or minus 1 dBm of LQ₂₆=−57.67 dBm (i.e. between −58.67 dBm and −56.67 dBm); and the result of decision block 730 will be “no.” Thus, as indicated by the arrow on the flow chart, the microcontroller 56 will exit the autonomous unstuck routine and return to the free swim or converge routine from which it came (block 790).

Next, another autonomous movement is attempted by the autonomous decoy device 10, but once again fails to some degree. The value of the link quality measurement taken at point 315 is LQ₃₁. Next, the registers are shifted and the link quality value is stored in the register representing the most current reading. Hence, R_{A} will contain LQ₃₁=−56.71 dBm; R_{B} will contain LQ₃₀=−56.36 dBm; R_{C} will contain LQ₂₉=−56.18 dBm; R_{D} will contain LQ₂₈=−56.62 dBm; R_{E} will contain LQ₂₇=−56.53 dBm; etc.

After the most current link quality measurement from the free swim routine has been taken and the registers have been shifted, the autonomous unstuck routine is started (block 702). Next, the microcontroller 56 compares the value of the most current link quality measurement to determine if it is within plus or minus 1 dBm of the value of the previous link quality measurement (decision block 715). Here, LQ₃₁=−56.71 dBm is within plus or minus 1 dBm of LQ₃₀=−56.36 dBm (i.e. between −57.36 dBm and −55.36 dBm); and the result of decision block 715 will be “yes.” Next, the microcontroller 56 compares the value of the most current link quality measurement to determine if it is within plus or minus 1 dBm of the value of the link quality measurement taken two instances previous (decision block 720). Here, LQ₃₁=−56.71 dBm is also within plus or minus 1 dBm of LQ₂₉=−56.18 dBm (i.e. between −57.18 dBm and −55.18 dBm); and the result of decision block 720 will be “yes.” Next, the microcontroller 56 compares the value of the most current link quality measurement to determine if it is within plus or minus 1 dBm of the value of the link quality measurement taken three instances previous (decision block 725). Here, LQ₃₁=−56.71 dBm is again within plus or minus 1 dBm of LQ₂₈=−56.62 dBm (i.e. between −57.62 dBm and −55.62 dBm); and the result of decision block 725 will be “yes.”

Following the arrow to the next and final decision block, the microcontroller 56 compares the value of the most current link quality measurement to determine if it is within plus or minus 1 dBm of the value of the link quality measurement taken four instances previous (decision block 730). Here, LQ₃₁=−56.71 dBm is also within plus or minus 1 dBm of LQ₂₇=−56.53 dBm (i.e. between −57.53 dBm and −55.53 dBm); and the result of decision block 730 will be “yes.” Thus, as the arrow in the flow chart indicates, block 735 is reached in the flow chart and the autonomous decoy device 10 is instructed to make a 180° right turn movement or a reverse movement 317 followed by a forward movement 319 to dislodge itself from the obstacle 120. It is to be appreciated that the autonomous movements made in block 735 may comprise extra thrusting power from the pump 80 (if available in the model used) and additional thrusting time than other autonomous movements used during the free swim and converge routines. Furthermore, in some variations of the unstuck routine, one or more shaker movements are executed by the autonomous decoy device 10 to aide in dislodging itself. Concluding description of the autonomous unstuck routine, the arrow from block 735 connects to block 790 whereby the microcontroller 56 will exit the autonomous unstuck routine and return to the free swim or converge routine from which it came.

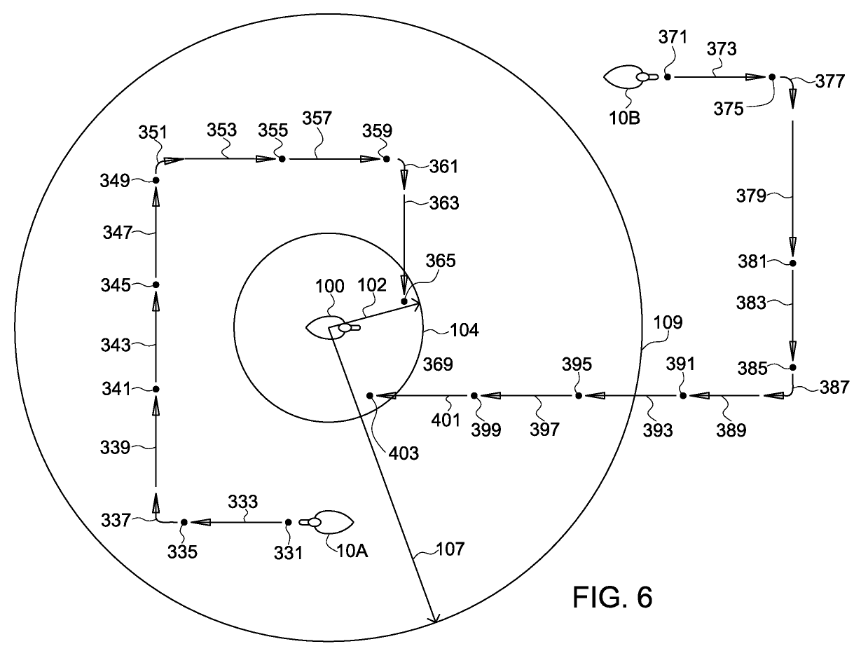

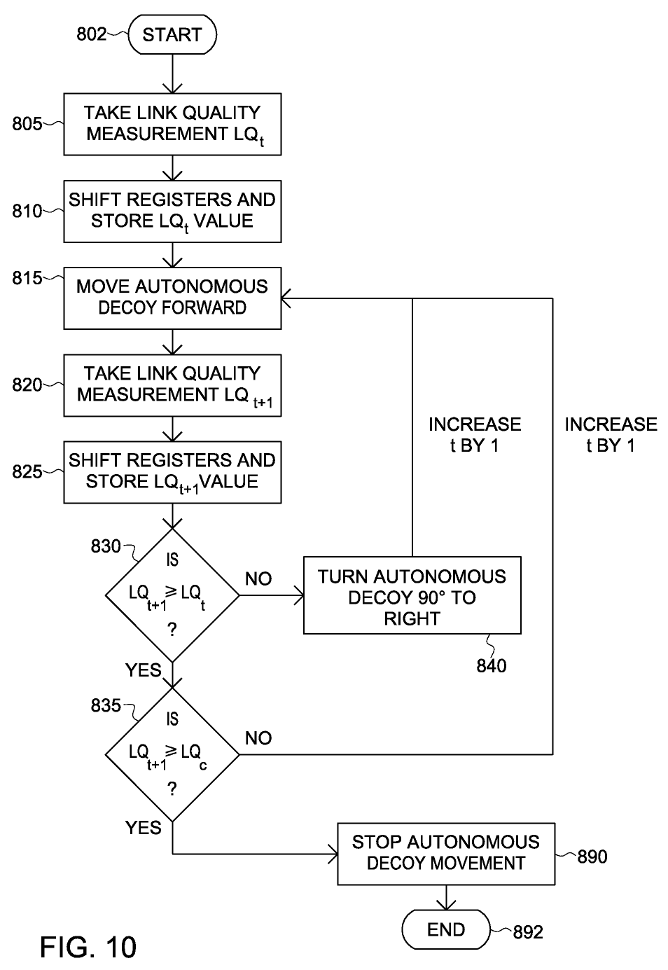

FIG. 6 is an overhead view showing two examples of an autonomous converge routine executed by the autonomous decoy device 10. A first example of the autonomous converge routine when the autonomous decoy device 10 receives the converge message from the beacon 100 is demonstrated with the autonomous decoy device 10a. A second example of the autonomous converge routine, which occurs when the autonomous decoy device exceeds the maximum distance circle 109 while executing a free swim routine is demonstrated with the autonomous decoy device 10b. FIG. 10 is a flow chart illustrating the operation and algorithm used for the autonomous converge routine.

Referring now to both the overhead view of FIG. 6 and the flow chart of FIG. 10, the autonomous converge routine may be demonstrated. In the first example, the variable t will equal 40 and begin with link quality measurement LQ₄₀. In the second example, the variable t will equal 60 and begin with link quality measurement LQ₆₀ the Starting the exemplary movements with the variable t at 40 and 60 is not in anyway limiting, but is merely suggestive of a continuation from a previous free swim routine and is useful to avoid confusion with other routines and examples described in this specification.

First, the autonomous decoy device 10a receives the converge message from the beacon 100 through the wireless reference signal 125. Upon receiving the converge message, the microcontroller 56 initiates the autonomous converge routine (block 802). Next, as indicated in block 805, a link quality measurement is taken. The value of the link quality measurement taken at point 331 is LQ₄₀. Next, the registers are shifted and the link quality value is stored in the register representing the most current reading (block 810). Hence, R_{A} will contain LQ₄₀; R_{B} will contain LQ₃₉; etc.

Next, as indicated in block 815, the autonomous decoy device 10a is instructed to move forward and executes a forward movement 333. Next, as indicated in block 820, a link quality measurement is taken. The value of the link quality measurement taken at point 335 is LQ₄₁. Next, the registers are shifted and the link quality value is stored in the register representing the most current reading (block 825). Hence, R_{A} will contain LQ₄₁; R_{B} will contain LQ₄₀; etc.

Next, the microcontroller 56 compares the value of the most current link quality measurement with the value of the previous link quality measurement (decision block 830). Here, as can be perceived from observing the two distances identified in the overhead view, point 335 is farther from the beacon 100 than point 331. Thus, the signal power value represented by LQ₄₁ will be less than LQ₄₀ and the result of decision block 830 will be “no.” Since the answer to the previous decision block was “no,” next as indicated in block 840, the autonomous decoy device 10a is instructed to turn 90° to the right and executes a 90° right turn movement 337. As instructed in the connector from block 840 to block 815, the variable t is increased by 1.

Next, as indicated in block 815, the autonomous decoy device 10a is instructed to move forward and executes a forward movement 339. Next, as indicated in block 820, a link quality measurement is taken. The value of the link quality measurement taken at point 341 is LQ₄₂. Next, the registers are shifted and the link quality value is stored in the register representing the most current reading (block 825). Hence, R_{A} will contain LQ₄₂; R_{B} will contain LQ₄₁; etc. Next, the microcontroller 56 compares the value of the most current link quality measurement with the value of the previous link quality measurement (decision block 830). Here, as can be perceived from observing the two distances identified in the overhead view, point 341 is closer to the beacon 100 than point 335. Thus, the signal power value represented by LQ₄₂ will be greater than LQ₄₁ and the result of decision block 830 will be “yes.”

Next, as indicated in decision block 835, the microcontroller 56 compares the value of the most current link quality measurement with the link quality value of the converge distance (LQ_{c}) from the beacon 100. Here, as can be perceived from observing the two distances identified in the overhead view, point 341 is outside of the converge circle 104. Thus, the signal power value represented by LQ₄₂ will be less than LQ_{c} and the result of decision block 835 will be “no.” This decision block basically identifies whether the autonomous decoy device 10a has indeed reach the converge radius 102; and if not, the autonomous converge routine continues autonomous movement to reach the converge circle 104. As instructed in the connector from decision block 835 to block 815, the variable t is increased by 1.

Next, as indicated in block 815, the autonomous decoy device 10a is instructed to move forward and executes a forward movement 343. Next, as indicated in block 820, a link quality measurement is taken. The value of the link quality measurement taken at point 345 is LQ₄₃. Next, the registers are shifted and the link quality value is stored in the register representing the most current reading (block 825). Hence, R_{A} will contain LQ₄₃; R_{B} will contain LQ₄₂; etc. Next, the microcontroller 56 compares the value of the most current link quality measurement with the value of the previous link quality measurement (decision block 830). Here, as can be perceived from observing the two distances identified in the overhead view, point 345 is slightly closer to the beacon 100 than point 341. Thus, the signal power value represented by LQ₄₃ will be greater than LQ₄₂ and the result of decision block 830 will be “yes.” Next, the question whether the converge circle 104 has been reached by the autonomous decoy device 10a is analyzed with an answer of “no” to decision block 835. As instructed in the connector from decision block 835 to block 815, the variable t is increased by 1.

Next, as indicated in block 815, the autonomous decoy device 10a is instructed to move forward and executes a forward movement 347. Next, as indicated in block 820, a link quality measurement is taken. The value of the link quality measurement taken at point 349 is LQ₄₄. Next, the registers are shifted and the link quality value is stored in the register representing the most current reading (block 825). Hence, R_{A} will contain LQ₄₄; R_{B} will contain LQ₄₃; etc. Next, the microcontroller 56 compares the value of the most current link quality measurement with the value of the previous link quality measurement (decision block 830). Here, as can be perceived from observing the two distances identified in the overhead view, point 349 is farther from the beacon 100 than point 345. Thus, the signal power value represented by LQ₄₄ will be less than LQ₄₄ and the result of decision block 830 will be “no.” Since the answer to the previous decision block was “no,” next as indicated in block 840, the autonomous decoy device 10a is instructed to turn 90° to the right and executes a 90° right turn movement 351.

Next, as indicated in block 815, the autonomous decoy device 10a is instructed to move forward and executes a forward movement 353. Next, as indicated in block 820, a link quality measurement is taken. The value of the link quality measurement taken at point 355 is LQ₄₅. Next, the registers are shifted and the link quality value is stored in the register representing the most current reading (block 825). Hence, R_{A} will contain LQ₄₅; R_{B} will contain LQ₄₄; etc. Next, the microcontroller 56 compares the value of the most current link quality measurement with the value of the previous link quality measurement (decision block 830). Here, as can be perceived from observing the two distances identified in the overhead view, point 355 is closer to the beacon 100 than point 349. Thus, the signal power value represented by LQ₄₅ will be greater than LQ₄₄ and the result of decision block 830 will be “yes.” Next, the question whether the converge circle 104 has been reached by the autonomous decoy device 10a is analyzed with an answer of “no” to decision block 835. As instructed in the connector from decision block 835 to block 815, the variable t is increased by 1.

Next, as indicated in block 815, the autonomous decoy device 10a is instructed to move forward and executes a forward movement 357. Next, as indicated in block 820, a link quality measurement is taken. The value of the link quality measurement taken at point 359 is LQ₄₆. Next, the registers are shifted and the link quality value is stored in the register representing the most current reading (block 825). Hence, R_{A} will contain LQ₄₆; R_{B} will contain LQ₄₅; etc. Next, the microcontroller 56 compares the value of the most current link quality measurement with the value of the previous link quality measurement (decision block 830). Here, as can be perceived from observing the two distances identified in the overhead view, point 359 is slightly farther from the beacon 100 than point 355. Thus, the signal power value represented by LQ₄₆ will be less than LQ₄₅ and the result of decision block 830 will be “no.” Since the answer to the previous decision block was “no,” next as indicated in block 840, the autonomous decoy device 10a is instructed to turn 90° to the right and executes a 90° right turn movement 361. As instructed in the connector from block 840 to block 815, the variable t is increased by 1.

Next, as indicated in block 815, the autonomous decoy device 10a is instructed to move forward and executes a forward movement 363. Next, as indicated in block 820, a link quality measurement is taken. The value of the link quality measurement taken at point 365 is LQ₄₇. Next, the registers are shifted and the link quality value is stored in the register representing the most current reading (block 825). Hence, R_{A} will contain LQ₄₇; R_{B} will contain LQ₄₅; etc. Next, the microcontroller 56 compares the value of the most current link quality measurement with the value of the previous link quality measurement (decision block 830). Here, as can be perceived from observing the two distances identified in the overhead view, point 365 is closer to the beacon 100 than point 359. Thus, the signal power value represented by LQ₄₇ will be greater than LQ₄₆ and the result of decision block 830 will be “yes.”

Next, as indicated in decision block 835, the microcontroller 56 compares the value of the most current link quality measurement with the link quality value of the converge distance (LQ_{c}) from the beacon 100. Here, as can be perceived from observing the two distances identified in the overhead view, point 365 is just inside of the converge circle 104. Thus, the signal power value represented by LQ₄₇ will be greater than LQ_{c} and the result of decision block 835 will be “yes.” Next, as indicated in block 890, the microcontroller 56 instructs the autonomous decoy device 10a to stop and cease autonomous movement. Hence, having reached the converge circle 104, the autonomous converge routine is ended (block 892).

In the second example of the converge routine, the autonomous decoy device 10b is performing a free swim routine, but drifts outside of the maximum distance circle 109 due to some external factor such, but not limited to, a strong gust of wind. As is frequently performed during the free swim routines, the microcontroller 56 performs a check to ensure that the autonomous decoy device 10b is within an allowable range of the beacon 100. The microcontroller 56 compares the value of the most current link quality measurement with the link quality value of the maximum allowable distance (LQ_{dmax}) from the beacon 100. Here, as can be perceived from observing the two distances identified in the overhead view, the autonomous decoy device 10b is outside of the maximum distance circle 109. Thus, the signal power value represented by LQ₅₉ (which is the link quality measurement where the autonomous decoy device 10b is located prior to beginning the converge routine) will be less than LQ_{dmax}. Hence, the free swim routine would be interrupted and the microcontroller 56 starts the converge routine (block 802).

Next, as indicated in block 805, a link quality measurement is taken. The value of the link quality measurement taken at point 371 is LQ₆₀. Next, the registers are shifted and the link quality value is stored in the register representing the most current reading (block 810). Hence, R_{A} will contain LQ₆₀; R_{B} will contain LQ₅₉; etc. Next, as indicated in block 815, the autonomous decoy device 10b is instructed to move forward and executes a forward movement 373.

Next, as indicated in block 820, a link quality measurement is taken. The value of the link quality measurement taken at point 375 is LQ₆₁. Next, the registers are shifted and the link quality value is stored in the register representing the most current reading (block 825). Hence, R_{A} will contain LQ₆₁; R_{B} will contain LQ₆₀; etc. Next, the microcontroller 56 compares the value of the most current link quality measurement with the value of the previous link quality measurement (decision block 830). Here, as can be perceived from observing the two distances identified in the overhead view, point 375 is farther from the beacon 100 than point 371. Thus, the signal power value represented by LQ₆₁ will be less than LQ₆₀ and the result of decision block 830 will be “no.” Since the answer to the previous decision block was “no,” next as indicated in block 840, the autonomous decoy device 10b is instructed to turn 90° to the right and executes a 90° right turn movement 377. As instructed in the connector from block 840 to block 815, the variable t is increased by 1.

Next, as indicated in block 815, the autonomous decoy device 10b is instructed to move forward and executes a forward movement 379. Next, as indicated in block 820, a link quality measurement is taken. The value of the link quality measurement taken at point 381 is LQ₆₂. Next, the registers are shifted and the link quality value is stored in the register representing the most current reading (block 825). Hence, R_{A} will contain LQ₆₂; R_{B} will contain LQ₆₁; etc. Next, the microcontroller 56 compares the value of the most current link quality measurement with the value of the previous link quality measurement (decision block 830). Here, as can be perceived from observing the two distances identified in the overhead view, point 381 is slightly closer to the beacon 100 than point 375. Thus, the signal power value represented by LQ₆₂ will be greater than LQ₆₁ and the result of decision block 830 will be “yes.” Next, as indicated in decision block 835, the microcontroller 56 compares the value of the most current link quality measurement with the link quality value of the converge distance (LQ_{c}) from the beacon 100. Here, as can be perceived from observing the two distances identified in the overhead view, point 381 is outside of the converge circle 104. Thus, the signal power value represented by LQ₆₂ will be less than LQ_{c} and the result of decision block 835 will be “no.” As instructed in the connector from decision block 835 to block 815, the variable t is increased by 1.

Next, as indicated in block 815, the autonomous decoy device 10b is instructed to move forward and executes a forward movement 383. Next, as indicated in block 820, a link quality measurement is taken. The value of the link quality measurement taken at point 385 is LQ₆₃. Next, the registers are shifted and the link quality value is stored in the register representing the most current reading (block 825). Hence, R_{A} will contain LQ₆₃; R_{B} will contain LQ₆₂; etc. Next, the microcontroller 56 compares the value of the most current link quality measurement with the value of the previous link quality measurement (decision block 830). Here, as can be perceived from observing the two distances identified in the overhead view, point 385 is farther from the beacon 100 than point 381. Thus, the signal power value represented by LQ₆₃ will be less than LQ₆₂ and the result of decision block 830 will be “no.” Since the answer to the previous decision block was “no,” next as indicated in block 840, the autonomous decoy device 10b is instructed to turn 90° to the right and executes a 90° right turn movement 387. As instructed in the connector from block 840 to block 815, the variable t is increased by 1.

Next, as indicated in block 815, the autonomous decoy device 10b is instructed to move forward and executes a forward movement 389. Next, as indicated in block 820, a link quality measurement is taken. The value of the link quality measurement taken at point 391 is LQ₆₄. Next, the registers are shifted and the link quality value is stored in the register representing the most current reading (block 825). Hence, R_{A} will contain LQ₆₄; R_{B} will contain LQ₆₃; etc. Next, the microcontroller 56 compares the value of the most current link quality measurement with the value of the previous link quality measurement (decision block 830). Here, as can be perceived from observing the two distances identified in the overhead view, point 391 is closer to the beacon 100 than point 385. Thus, the signal power value represented by LQ₆₄ will be greater than LQ₆₃ and the result of decision block 830 will be “yes.” Next, the question whether the converge circle 104 has been reached by the autonomous decoy device 10b is analyzed with an answer of “no” to decision block 835. As instructed in the connector from decision block 835 to block 815, the variable t is increased by 1.

Next, as indicated in block 815, the autonomous decoy device 10b is instructed to move forward and executes a forward movement 393. Next, as indicated in block 820, a link quality measurement is taken. The value of the link quality measurement taken at point 395 is LQ₆₅. Next, the registers are shifted and the link quality value is stored in the register representing the most current reading (block 825). Hence, R_{A} will contain LQ₆₅; R_{B} will contain LQ₆₄; etc. Next, the microcontroller 56 compares the value of the most current link quality measurement with the value of the previous link quality measurement (decision block 830). Here, as can be perceived from observing the two distances identified in the overhead view, point 395 is closer to the beacon 100 than point 391. Thus, the signal power value represented by LQ₆₅ will be greater than LQ₆₄ and the result of decision block 830 will be “yes.” Next, the question whether the converge circle 104 has been reached by the autonomous decoy device 10b is analyzed again with an answer of “no” to decision block 835. As instructed in the connector from decision block 835 to block 815, the variable t is increased by 1.

Next, as indicated in block 815, the autonomous decoy device 10b is instructed to move forward and executes a forward movement 397. Next, as indicated in block 820, a link quality measurement is taken. The value of the link quality measurement taken at point 399 is LQ₆₆. Next, the registers are shifted and the link quality value is stored in the register representing the most current reading (block 825). Hence, R_{A} will contain LQ₆₆; R_{B} will contain LQ₆₅; etc. Next, the microcontroller 56 compares the value of the most current link quality measurement with the value of the previous link quality measurement (decision block 830). Here, as can be perceived from observing the two distances identified in the overhead view, point 399 is closer to the beacon 100 than point 395. Thus, the signal power value represented by LQ₆₆ will be greater than LQ₆₅ and the result of decision block 830 will be “yes.” Next, the question whether the converge circle 104 has been reached by the autonomous decoy device 10b is analyzed again with an answer of “no” to decision block 835. As instructed in the connector from decision block 835 to block 815, the variable t is increased by 1.

Next, as indicated in block 815, the autonomous decoy device 10b is instructed to move forward and executes a forward movement 401. Next, as indicated in block 820, a link quality measurement is taken. The value of the link quality measurement taken at point 403 is LQ₆₇. Next, the registers are shifted and the link quality value is stored in the register representing the most current reading (block 825). Hence, R_{A} will contain LQ₆₇; R_{B} will contain LQ₆₆; etc. Next, the microcontroller 56 compares the value of the most current link quality measurement with the value of the previous link quality measurement (decision block 830). Here, as can be perceived from observing the two distances identified in the overhead view, point 403 is closer to the beacon 100 than point 399. Thus, the signal power value represented by LQ₆₇ will be greater than LQ₆₆ and the result of decision block 830 will be “yes.”

Next, as indicated in decision block 835, the microcontroller 56 compares the value of the most current link quality measurement with the link quality value of the converge distance (LQ_{c}) from the beacon 100. Here, as can be perceived from observing the two distances identified in the overhead view, point 403 is inside of the converge circle 104. Thus, the signal power value represented by LQ₆₇ will be greater than LQ_{c} and the result of decision block 835 will be “yes.” Next, as indicated in block 890, the microcontroller 56 instructs the autonomous decoy device 10b to stop autonomous movement. Hence, having reached the converge circle 104, the autonomous converge routine is ended (block 892) and the microcontroller 56 returns to the free swim routine from which it came.

One Method of Hunting with an Autonomous Decoy Device:

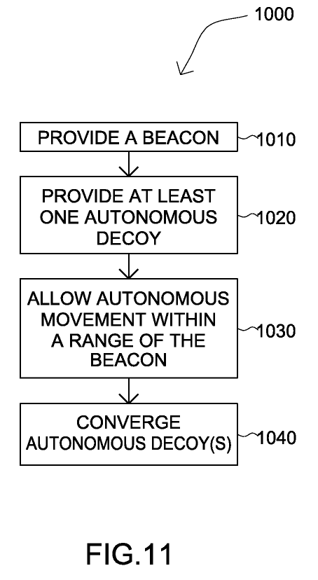

FIG. 11 is a flow chart illustrating a method of hunting with at least one autonomous decoy device 10 such as the embodiment shown in FIG. 1. The method of hunting 1000 may be applied in a variety of hunting applications such as, but not limited to, hunting waterfowl on or near a body of water.

First, as shown in block 1010, the user provides a beacon 100. The beacon 100 provides a reference signal 125 for use with the at least one autonomous decoy device 10. Where the method of hunting 1000 is applied to hunting waterfowl, the beacon 100 may be a buoyant waterfowl decoy and placed on the surface of the body of water. The beacon 100 may also be tethered in some fashion to allow it from excessively drifting on the surface of the water.

Next, as shown in block 1020, the at least one autonomous decoy device 10 is provided. Again, where the method of hunting 1000 is applied to hunting waterfowl, the at least one autonomous decoy device 10 may comprise a head 12 and body 14 of a buoyant waterfowl decoy attached to a frame 16 and a hull 18. The at least one autonomous decoy device 10 may be placed on the surface of the body of water.

Where the use of a plurality of autonomous decoy devices 10 is desired, the autonomous decoy devices 10 may be spread in various locations around the beacon 100. Alternatively, standard buoyant decoys may be deployed along with the at least one autonomous decoy device 10. If a tighter decoy spread is desired, a maximum allowable distance for which the at least one autonomous decoy 10 may swim from the beacon may be utilized such as but not limited to 30 feet, 15 feet, or 10 feet.

Next, as described in block 1030, the autonomous decoy device 10 is allowed to execute autonomous movements within the maximum allowable distance from the beacon 100. The autonomous movement may comprise the autonomous pinwheel free swim routine or autonomous double-L free swim routine. Additionally, the autonomous unstuck routine may require to be executed by the autonomous decoy device 10 during the autonomous free swim routine. While the at least one autonomous decoy device 10 is swimming, the user awaits with gun ready for game to enter the target area.

Next, as described in block 1040, the at least one autonomous decoy device 10 is instructed to converge toward the beacon 100. The user presses a converge button on the beacon 100. By pressing the converge button on the beacon 100, the converge message is sent via the wireless reference signal 125 to the at least one autonomous decoy device 10. The at least one autonomous decoy device 10 then executes the converge routine.

### Alternative Embodiments and Variations

The embodiment of the autonomous decoy device and variations thereof, and method of use as illustrated in the accompanying figures and described above, are merely exemplary and are not meant to limit the scope of the invention. It is to be appreciated that numerous variations to the invention have been contemplated as would be obvious to one of ordinary skill in the art with the benefit of this disclosure. All variations of the invention that read upon the claims are intended and contemplated to be within the scope of the invention.

While the described embodiment relies upon a generally stationary beacon, in variations the beacon or master decoy can swim as well. In one variation, for instance, the master may be controlled by a user using a remote control. Furthermore, in one embodiment, each decoy of the flock may be identical and the determination of whether a particular decoy behaves as the autonomous decoy device or the beacon depends largely on the mode setting of the specific decoy.

While the plurality of autonomous decoy devices is described as being almost fully autonomous, there may be variations that permit the user to have some or partial control of one or more autonomous decoy devices or even the entire flock. In this manner by overriding the autonomy, the user can recall the individual autonomous decoy devices. In one variation, the user has a remote control that when set to a particular autonomous decoy device and activated causes the autonomous decoy device to return to the beacon or even to the user's location. In yet another variation, the user has a control that when activated changes the frequency or character of the wireless reference signal to cause the autonomous decoy device 10 to change their mode and hone in on the beacon.

In yet other contemplated embodiments, a flock or plurality of autonomous decoy devices may not include a beacon. Rather, autonomous decoy device comprising the flock may include a transceiver and associated logic that lets it ascertain its position in the flock and adjust its swimming behavior accordingly. Other contemplated embodiments may include a shore-based beacon that may or may not contain logic but may not necessarily resemble a waterfowl. For instance, the beacon could resemble a rock jutting out of the shoreline of the body of water or a lily pad resting on the shoreline of the body of water. The beacon in a shore-based configuration or even on the surface of the water may employ a variety of direction antennas or other waveguide methods to create a variety of wave dispersions and resulting decoy spreads.

Numerous other embodiments are contemplated as well as would be obvious to one of ordinary skill in the art to which the invention pertains given the benefit of this disclosure. For instance, an embodiment is contemplated wherein the logic or brain that determines the movement of the flock is contained within the beacon or master decoy. For instance, a remote-controlled slave decoy device may transmit a unique digital or analog signal that is analyzed by the beacon or master decoy, and based on the signal the beacon or master decoy may transmit swimming instructions to the remote-controlled slave decoy device. In this fashion, the beacon or master decoy may control the entire flock of remote-controlled slave decoy devices. If the remote-controlled slave decoy device strays too far, the beacon or master decoy can alter the remote-controlled slave decoy device's swimming behavior to bring it within an allowable distance from the beacon or master decoy.

It is appreciated from the foregoing that the variations on an autonomous decoy device is rather extensive and that these and other obvious variations fall within the general scope of the invention as provided herein above.

We claim:

1) An autonomous decoy device comprising:
a decoy shell, the shell having a form resembling an animal in life size or near life size proportions;
a propulsion system, the propulsion system adapted to move the decoy device in or on a desired medium;
a steering apparatus, the steering apparatus adapted to control the direction of movement of the decoy device;
a receiver, the receiver adapted to receive an electromagnetic signal and determine a relative strength of the signal;
a memory, the memory being adapted to store at least one instruction set; and
a microcontroller, the microcontroller adapted to control the propulsion system and the steering apparatus based on the at least one instruction set and the relative strength of the signal.

2) The autonomous decoy device of claim 1, wherein the memory is further adapted to store a plurality of values for the relative strength of the signal and the microcontroller is further adapted to compare the plurality of values for the relative strength of the signal to each other and to a plurality of constant values.

3) The autonomous decoy device of claim 1, wherein the decoy shell comprises a head portion with a face and a body portion, the head portion being configured to point the face portion generally in a direction the decoy device is traveling.

4) The autonomous decoy device of claim 3, wherein the head portion is operatively coupled to the steering apparatus through a plurality of gears, the plurality of gears causing the head to rotate generally in the direction that the autonomous decoy device is traveling.

5) The autonomous decoy device of claim 1, further comprising a substantially watertight hull and being adapted for travel on a water surface, the propulsion system comprising:
a water pump having an water inlet and a water outlet; and
a water nozzle operatively coupled to the water outlet;
wherein during operation the water pump draws water in the water inlet and forces the water from the water outlet and through the water nozzle creating a propelling force.

6) The autonomous decoy device of claim 3, further including a hull, wherein the propulsion system comprises:
a water input in the hull;
a pump positioned inside the hull and the decoy shell, the pump having an inlet and an outlet, the inlet coupled to a first conduit, the first conduit coupled to the water input; and
a water output in the hull, the water output coupled to a second conduit, the second conduit coupled to the outlet of the pump;
wherein the pump draws water from the water input through the first conduit and into the inlet, and forces the water through the outlet through the second conduit and out of the water output creating a propelling force.

7) The autonomous decoy device of claim 5, further including a shaker assembly, the shaker assembly being in communications with the microcontroller and adapted to shake the autonomous decoy device.

8) The autonomous decoy device of claim 5, wherein the shaker assembly comprises an electric motor having a shaft coupled to a weight at a first location on the weight, the weight having a center of gravity located at a second location, the second location being spaced from the first location.

9) The autonomous decoy device of claim 5, wherein the at least one instruction set includes a free swim routine directing the movement of the autonomous decoy device based on the strength of the reference signal.

10) The autonomous decoy device of claim 9, wherein the at least one instruction set further includes an autonomous unstuck routine, the microcontroller executing the autonomous unstuck routine being adapted to (i) ascertain that the autonomous decoy is stuck by comparing periodic readings of the strength of the reference signal, and (ii) controlling the steering apparatus and the pump to increase the probability of dislodging the autonomous decoy device.

11) The autonomous decoy device of claim 9, wherein the at least one instruction set further includes an autonomous converge routine, the microcontroller executing the autonomous converge routine being adapted to move the autonomous decoy device towards the location from which the reference signal is emanating.

12) The autonomous decoy device of claim 6, wherein the decoy shell is one of a duck and a goose.

13) An autonomous decoy system comprising:
a beacon adapted to transmit a reference signal, the beacon including, an antenna,
a wireless transmitter; and
one or more autonomous decoy devices, the one or more autonomous decoy devices each including,
a decoy shell, the shell having a form resembling an animal in life size or near life size proportions;
a propulsion system, the propulsion system adapted to move the decoy device in or on a desired medium;
a steering apparatus, the steering apparatus adapted to control the direction of movement of the decoy device;
a wireless receiver, the receiver adapted to periodically receive the reference signal and determine a relative strength of the signal;
a memory, the memory being adapted to store at least one instruction set; and
a microcontroller, the microcontroller adapted to control the propulsion system and the steering apparatus based on the at least one instruction set and the relative strength of the reference signal.

14) The system of claim 13, wherein the beacon further comprises a decoy shell, the shell having a form resembling an animal in life size or near life size proportions.

15) The system of claim 14, wherein the one or more autonomous decoy devices and the beacon are adapted to float and operate on a body of water.

16) The system of claim 15, wherein the at least one instruction set comprises a swim routine, the swim routine when executed by the microprocessor causing the autonomous decoy device to autonomously swim within a predetermined radius around the beacon.

17) A method of deploying the system of claim 1, the method comprising:
placing the beacon to transmit the reference signal in a body of water where the user wishes to create a decoy spread;
placing the one or more autonomous decoy devices near the beacon;
allowing the one or more autonomous decoy devices to autonomously swim within a range of the beacon; and
converging the one or more autonomous decoy devices toward the beacon.

18) The method of claim 17 further comprising,
placing a plurality of floating decoy shells near the one or more autonomous decoy devices, each of the plurality of floating decoy shells having a form resembling an animal in life size or near life size proportions.

19) The system of claim 13 wherein (i) the one or more autonomous decoy devices and the beacon are adapted to float and operate on a body of water; and (ii) the beacon further includes a tether and an anchor, the tether being secured to a body of the beacon at one end and to the anchor at another end.

20) A system comprising:
a buoyant beacon including a beacon transceiver; and
a plurality of decoys resembling water fowl adapted to float and operate on a body of water, each decoy including (i) a decoy transceiver adapted for wireless communication with the beacon transceiver, (ii) a propulsion system, (iii) a steering apparatus and (iv) a controller operatively coupled with the decoy transceiver, the propulsion system and the steering apparatus;
wherein each decoy is adapted to move on the body of water within a predetermined radius of the buoyant beacon based on communication with the buoyant.
